(19) United States
(12) Patent Application Publication
(10) Pub. No.: US 2026/0139419 A1
(43) Pub. Date: May 21, 2026

(54) PARTICLE-CONTAINING THERMAL BARRIER MATERIALS COMPRISING MICROGLASS FIBERS AND/OR SYNTHETIC FIBERS

(71) Applicant: Hollingsworth & Vose Company, East Walpole, MA (US)

(72) Inventors: Zhiping Jiang, Nashua, NH (US); Girisha Basavaraju, Karnataka (IN)

(73) Assignee: Hollingsworth & Vose Company, East Walpole, MA (US)

(21) Appl. No.: 19/269,459

(22) Filed: Jul. 15, 2025

Related U.S. Application Data
(63) Continuation-in-part of application No. 18/949,831, filed on Nov. 15, 2024.

(51) Int. Cl. D04H 1/4382; D04H 1/4218; D04H 3/16; H01M 50/437; H01M 50/44; H01M 50/489

(52) U.S. Cl. CPC D04H 1/43835; D04H 1/4218; D04H 1/43838; D04H 3/16; H01M 50/437; H01M 50/44; H01M 50/489

(57) ABSTRACT

Thermal barrier materials are generally described. The thermal barrier materials described herein can have a number of advantages. For example, in some embodiments, a thermal barrier material has desirable thermal properties, such as low thermal conductivity and/or high thermal stability. As another example, in some embodiments, a thermal barrier material has desirable structural properties, such as having a high porosity, high pore tortuosity, and/or a low air permeability. In some embodiments, one or more of the desirable structural properties of a thermal barrier material may enhance the mechanical resiliency of the material. For example, in some embodiments, the structural properties of the material may enhance the compressibility and/or the elasticity of the material. In some embodiments, one or more of the desirable structural properties of a thermal barrier material may enhance the thermal insulation performance of the thermal barrier material. For instance, a thermal barrier material may have a structural property that reduces the thermal conductivity of the thermal barrier material. The thermal barrier materials described herein may also have a combination of desirable thermal and structural properties.

### RELATED APPLICATIONS

This application is a continuation-in-part of U.S. patent application Ser. No. 18/949,831, filed Nov. 15, 2024, and entitled “Particle-Containing Thermal Barrier Materials,” which is incorporated herein by reference in its entirety for all purposes.

### FIELD

Articles and associated systems and methods for thermal barrier materials are generally described.

### BACKGROUND

Electrochemical cells such as lithium-ion electrochemical cells or electrochemical cells with lithium metal anodes can overheat or catch fire during use. If a battery comprising a plurality of electrochemical cells does not include appropriate thermal barriers, heat and/or fire that is generated in one electrochemical cell may undesirably spread to others, which can cause a safety hazard and/or diminish overall battery performance. Accordingly, improved thermal barrier materials are needed.

### SUMMARY

Thermal barrier materials, related components, and related methods are generally described. In one aspect, a thermal barrier material is described. In some embodiments, the thermal barrier material comprises: a non-woven fiber web, comprising: microglass fibers; synthetic fibers; and thermal conductivity-reducing particles, wherein the synthetic fibers make up less than or equal to 60 wt % of the non-woven fiber web, and the non-woven fiber web has an air permeability less than or equal to 5 CFM.

In another aspect, a thermal barrier material is provided. In some embodiments, the thermal barrier material comprises: a non-woven fiber web, comprising: microglass fibers; and thermal conductivity-reducing particles, wherein: the microglass fibers make up greater than or equal to 20 wt % of the non-woven fiber web, and the non-woven fiber web has an air permeability less than or equal to 5 CFM.

In another aspect, a thermal barrier material is provided. In some embodiments, the thermal barrier material comprises: a non-woven fiber web, comprising: microglass fibers; and thermal conductivity-reducing particles, wherein the non-woven fiber web has a V-0 rating under UL 94 (2021).

In another aspect, a thermal barrier material is provided. In some embodiments, the thermal barrier material comprises: a non-woven fiber web, comprising: microglass fibers; and mica particles, wherein the non-woven fiber web has an air permeability less than or equal to 5 CFM.

In another aspect, a thermal barrier material is provided. In some embodiments, the thermal barrier material comprises: a non-woven fiber web, comprising: glass fibers; and silicon carbide particles; wherein the non-woven fiber web has an air permeability less than or equal to 5 CFM.

In another aspect, a battery is provided. In some embodiments, the battery comprises: a plurality of electrochemical cells comprising a first electrochemical cell and a second electrochemical cell; and a non-woven fiber web positioned between the first and second electrochemical cells, wherein: the non-woven fiber web comprises microglass fibers and thermal conductivity-reducing particles, and the non-woven fiber web has an air permeability less than or equal to 5 CFM

In another aspect, a battery is provided. In some embodiments, the battery comprises a plurality of modules comprising a first module and a second module; and a non-woven fiber web positioned between the first and second modules, wherein: the non-woven fiber web comprises microglass fibers and thermal conductivity-reducing particles, and the non-woven fiber web has an air permeability less than or equal to 5 CFM.

In another aspect, a thermal barrier material is provided. In some embodiments, the thermal barrier material comprises: a non-woven fiber web, comprising: fibrillated synthetic fibers; and mica particles, wherein the non-woven fiber web as an air permeability less than or equal to 5 CFM.

In another aspect, a thermal barrier material is provided. In some embodiments, the thermal barrier material comprises: a non-woven fiber web, comprising: synthetic fibers; and thermal conductivity-reducing particles, wherein: the synthetic fibers make up less than or equal to 60 wt % of the non-woven fiber web, and the non-woven fiber web has an air permeability less than or equal to 5 CFM.

In another aspect, a thermal barrier material is provided. In some embodiments, the thermal barrier material comprises: a non-woven fiber web, comprising: fibrillated synthetic fibers; and thermal conductivity-reducing particles, wherein: the fibrillated synthetic fibers make up less than or equal to 60 wt % of the non-woven fiber web, and the non-woven fiber web has an air permeability of less than or equal to 5 CFM.

In another aspect, a battery is provided. In some embodiments, the battery comprises: a plurality of electrochemical cells comprising a first electrochemical cell and a second electrochemical cell; and a non-woven fiber web positioned between the first and second electrochemical cells, wherein: the non-woven fiber web comprises fibrillated synthetic fibers and conductivity-reducing particles, and the non-woven fiber web has an air permeability less than or equal to 5 CFM.

In another aspect, a battery is provided. In some embodiments, the battery comprises: a plurality of modules comprising a first module and a second module; and a non-woven fiber web positioned between the first and second modules, wherein: the non-woven fiber web comprises fibrillated synthetic fibers and thermal conductivity-reducing, and the non-woven fiber web has an air permeability of less than or equal to 5 CFM.

Other advantages and novel features of the present disclosure will become apparent from the following detailed description of various non-limiting embodiments of the disclosure when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1A presents a top-view schematic of a nonlimiting non-woven fiber web, according to some embodiments;

FIG. 1B presents a cross-sectional schematic of a nonlimiting non-woven fiber web, according to some embodiments;

FIG. 1C presents a cross-sectional schematic of a nonlimiting non-woven fiber web, according to some embodiments;

FIG. 1D presents a cross-sectional schematic of a thermal conductivity-reducing particle in a non-woven fiber web, according to some embodiments;

FIG. 1E presents a cross-sectional schematic of the footprint of a thermal conductivity-reducing particle in a non-woven fiber web, according to some embodiments.

FIG. 2A presents a side-view schematic of a non-woven fiber web positioned between a first electrochemical cell and a second electrochemical cell, according to some embodiments;

FIG. 2B presents a cross-sectional schematic of a nonlimiting battery comprising more than two electrochemical cells and more than one non-woven fiber web, according to some embodiments;

FIG. 3 presents a cross-sectional schematic of a non-woven fiber web positioned between a first module and a second module, according to some embodiments;

FIG. 4 presents a schematic of an experimental set up that was employed to measure insulation performance, according to some embodiments;

FIG. 5 is a chart showing the insulation performance of non-woven fiber webs, according to some embodiments;

FIG. 6A presents a scanning electron micrograph of a non-woven fiber web, according to some embodiments;

FIG. 6B presents a scanning electron micrograph of a non-woven fiber web, according to some embodiments;

FIG. 6C presents a scanning electron micrograph of a non-woven fiber web, according to some embodiments;

FIG. 7 presents a scanning electron micrograph of a fibrillated aramid fiber, according to some embodiments;

FIG. 8 is a photograph of a hot plate testing experimental set up that was employed to measure insulation performance, according to some embodiments;

FIG. 9 is a chart showing the thermal insulation performance of a non-woven fiber web, according to some embodiments;

FIG. 10 is a photograph of a torch testing experimental set up that was employed to measure insulation performance, according to some embodiments; and

FIG. 11 is a chart showing the thermal insulation performance of a non-woven fiber web, according to some embodiments.

### DETAILED DESCRIPTION

Thermal barrier materials are generally described. The thermal barrier materials described herein can have a number of advantages. For example, in some embodiments, a thermal barrier material has desirable thermal properties, such as low thermal conductivity and/or high thermal stability. As another example, in some embodiments, a thermal barrier material has desirable structural properties, such as having a high porosity, high pore tortuosity, and/or a low air permeability. In some embodiments, one or more of the desirable structural properties of a thermal barrier material may enhance the mechanical resiliency of the material. For example, in some embodiments, the structural properties of the material may enhance the compressibility and/or the elasticity of the material. In some embodiments, one or more of the desirable structural properties of a thermal barrier material may enhance the thermal insulation performance of the thermal barrier material. For instance, a thermal barrier material may have a structural property that reduces the thermal conductivity of the thermal barrier material. The thermal barrier materials described herein may also have a combination of desirable thermal and structural properties.

In some embodiments, a thermal barrier material takes the form of a non-woven fiber web. A non-woven fiber web may comprise one or more components that is advantageous for use in a thermal barrier material. For example, a non-woven fiber web may comprise one or more components that enhance a structural property and/or the thermal insulation performance of a non-woven fiber web.

One example of a component that enhances a thermal insulation performance of a non-woven fiber web is thermal conductivity-reducing particles. Such particles may reduce the thermal conductivity of the non-woven fiber web. Some such particles may themselves have low thermal conductivities and so directly reduce the thermal conductivity through the portions of the non-woven fiber web in which they are positioned.

It is also possible for thermal conductivity-reducing particles to have other properties which can reduce the thermal conductivity of such a non-woven fiber web, such as high porosities, high surface areas, large aspect ratio, high refractive indices, and/or high infrared absorbance. In some embodiments, thermal conductivity-reducing particles may be opacifiers. Without wishing to be bound by any particular theory, it is believed that thermal conductivity-reducing particles with high porosities and/or high surface areas may reduce the sizes of the pores in the non-woven fiber webs in which they are positioned and thereby reduce heat convection therethrough. It is also believed that thermal conductivity-reducing particles with large aspect ratios may increase the tortuosity of pores present in the non-woven fiber webs in which they are positioned, particularly when oriented such that they are stacked along their shortest principal axis, which is believed to reduce heat convection therethrough. It is also believed that thermal conductivity-reducing particles with high refractive indices, with high infrared absorbance, and/or particles that are infrared opacifiers may reduce radiative heat transfer through non-woven fiber webs in which they are positioned.

Another example of a component that enhances the thermal insulation performance of a non-woven fiber web is a flame-resistant resin. Without wishing to be bound by any particular theory, it is believed that flame-resistant resins may advantageously bind the components of the non-woven fiber web together and are safe to use in high-temperature environments.

In some embodiments, a non-woven fiber web may comprise one or more components that enhance the structural properties and/or thermal insulation performance of the non-woven fiber web due to having small dimensions and/or comprising structures which have small dimensions. Non-limiting examples of such components include microglass fibers, particles that have low diameters, fibrillated fibers, and aerogels. Without wishing to be bound by any particular theory, it is believed that components having small dimensions may enhance the mechanical resiliency of the non-woven fiber web by enhancing the compressibility and/or elasticity of the non-woven fiber web. It is believed that components having small dimensions enhance compressibility and/or elasticity by reducing the pore size of the non-woven fiber web while allowing the web to maintain a high porosity. Also without wishing to be bound by any particular theory, it is believed that having a high porosity enhances the compressibility of a material by increasing the amount of unoccupied volume in the material which can be compressed. It is also believed that porous materials having small pore sizes may have enhanced elasticity as smaller unoccupied volumes may rebound after compression more quickly and/or more completely.

Without wishing to be bound by any particular theory, it is also believed that components having small dimensions may decrease the air permeability of the non-woven fiber web, which is believed to reduce the thermal conductivity of the non-woven fiber web. Also without wishing to be bound by any particular theory, it is believed that such components may reduce the air permeability of the non-woven fiber web by decreasing the size of the pores and/or increasing the tortuosity of the pores in the non-woven fiber web. In some embodiments, a non-woven fiber web may comprise microglass fibers and/or fibrillated fibers (e.g., fibrillated synthetic fibers) and thermal conductivity-reducing particles having small diameters. Without wishing to be bound by any particular theory, it is believed that non-woven fiber webs comprising microglass fibers and/or fibrillated fibers have relatively fine pore structures, which improves the entanglement of thermal conductivity-reducing particles in the web. In some embodiments in which a non-woven fiber web comprises fibrillated fibers, it is believed that the fibrils of the fibrillated fibers may contribute to the development of a relatively fine pore structure.

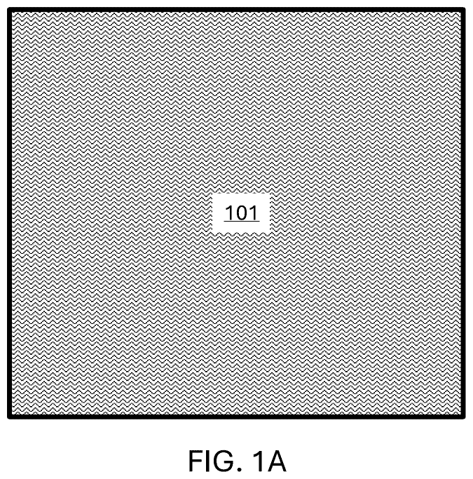

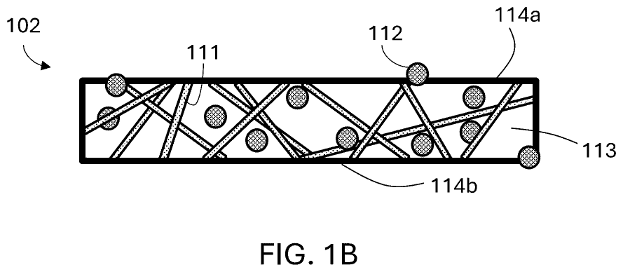

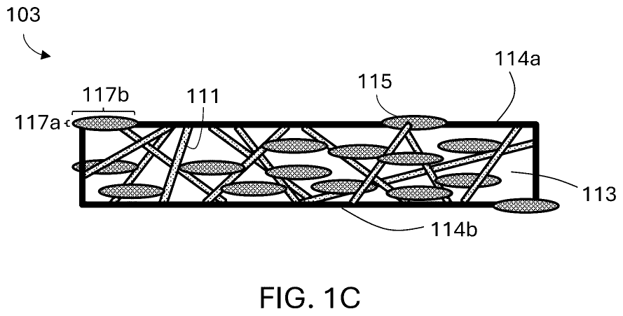

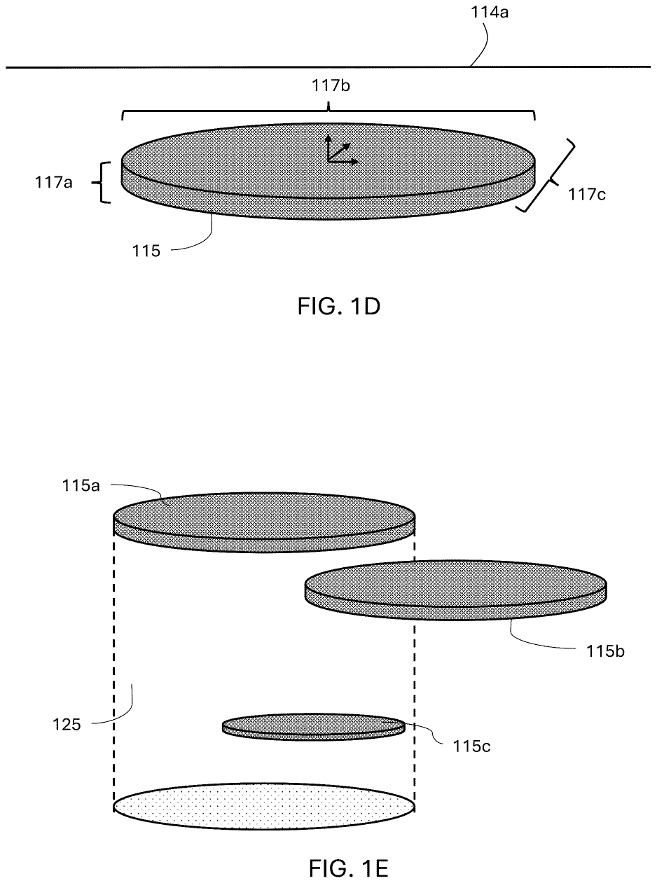

FIG. 1A presents a top-view schematic of a nonlimiting non-woven fiber web 101. Some non-woven fiber webs may be configured for use as thermal barrier materials to inhibit the flow of heat between neighboring objects. For example, some non-woven fiber webs may be configured to inhibit the flow of heat between electrochemical cells of a battery, thereby improving battery performance and/or safety. For instance, as described in further detail elsewhere herein, a non-woven fiber web may have a particularly low thermal conductivity and/or air permeability. In certain embodiments, a non-woven fiber web may comprise one or more components that reduce the thermal conductivity and/or air permeability of the web. In some embodiments, a non-woven fiber web may comprise one or more flame-resistant materials.

In some embodiments, a non-woven fiber web may comprise particles, such as thermal conductivity-reducing particles (e.g., particles that reduce the thermal conductivity of the non-woven fiber web in which they are positioned). FIG. 1B presents a cross-sectional schematic of a nonlimiting non-woven fiber web 102 comprising the fibers 111 and the thermal conductivity-reducing particles 112. In some embodiments, the thermal conductivity-reducing particles 112 may be present in the interior 113 of the non-woven fiber web and/or at one or both surfaces of the non-woven fiber web 114a and 114b. In some embodiments, the non-woven fiber web 102 may comprise pores between the fibers 111. The thermal conductivity-reducing particles 112 may be at least partially or completely contained within at least a portion of the pores between the fibers 111 and/or may partially or fully fill some or all of the pores between the fibers 111. In some embodiments, the fibers 111 may stabilize the thermal conductivity-reducing particles 112 present in the pores by facilitating the entanglement of the thermal conductivity-reducing particles in the non-woven fiber web, which may reduce or prevent shedding of the thermal conductivity-reducing particles from the non-woven fiber web. In certain embodiments, the thermal conductivity-reducing particles 112 may decrease the mean flow pore size of the pores in non-woven fiber web 102.

In some embodiments, a non-woven fiber web may comprise particles, such as thermal conductivity-reducing particles, which have relatively high aspect ratios. FIG. 1C presents a cross-sectional schematic of a nonlimiting non-woven fiber web 103 comprising fibers 111 and thermal conductivity-reducing particles 115 having relatively high aspect ratios. In some embodiments, the thermal conductivity-reducing particles 115 may have three principal axes, including a shortest principal axis 117a and a longest principal axis 117b. In some embodiments, the shortest principal axis 117a may be much shorter than the longest principal axis 117b and the third principal axis 117c as shown in FIG. 1D, which shows a close-up perspective view of a single thermal conductivity-reducing particle in a non-woven fiber web. In some embodiments, the thermal conductivity-reducing particles 115 may have an orientation relative to a surface of the non-woven fiber web. For example, in some embodiments, the shortest principal axis 117a of a thermal conductivity-reducing particle may be substantially perpendicular to the surface of the non-woven fiber web.

FIG. 1D depicts a single thermal conductivity-reducing particle positioned in a non-woven fiber web. The thermal conductivity-reducing particle 115 has a shortest principal axis 117a, a longest principal axis 117b, and a third principal axis 117c, and the shortest principal axis 117a is substantially perpendicular to a surface of a non-woven fiber web 114a. In some embodiments, a plurality of the thermal conductivity-reducing particles 115 may be oriented such that their shortest principal axes are substantially perpendicular to the surface of the non-woven fiber web.

In some embodiments, a non-woven fiber web comprises thermal conductivity-reducing particles that are stacked along their shortest principal axes. For instance, a non-woven fiber web may comprise thermal conductivity-reducing particles that are arranged such that they are proximate to each other spatially and have shortest principal axes that have similar orientations. Thermal conductivity-reducing particles may have a “footprint,” which may be a volume having an area defined by the two longest principal axes of the thermal conductivity-reducing particle and a height defined by the longest principal axis of the footprint.

For example, in FIG. 1E, thermal conductivity-reducing particle 115a has a footprint 125. In some embodiments, a thermal conductivity-reducing particle extends into the footprint of the other particle. For example, in FIG. 1E, the thermal conductivity-reducing particles 115b and 115c extend into the footprint 125 of the thermal conductivity-reducing particle 115a. The thermal conductivity-reducing particle 115b is partially positioned in the footprint 125 of the thermal conductivity-reducing particle 115a and the thermal conductivity-reducing particle 115c is fully positioned in the footprint 125 of the thermal conductivity-reducing particle 115a.

In some embodiments in which one thermal conductivity-reducing particle extends into the footprint of another, these thermal-conductivity reducing particles may have shortest principal axes that have substantially the same orientation (e.g. the shortest principal axes of the adjacent thermal-conductivity reducing particles may be substantially parallel to each other, and/or within 30°, 20°, 15°, 10°, 5°, 2°, or 1° of each other). In some embodiments, one or more fibers 111 may be located between thermal conductivity-reducing particles that are stacked along their principal axes (e.g., in the above-described manner). In some embodiments, thermal conductivity-reducing particles that are stacked along their principal axes (e.g., in the above-described manner) may be in physical contact with each other. In some embodiments, a non-woven fiber web may comprise one or more (e.g., two or more, three or more, four or more, etc.) stacks of thermal conductivity-reducing particles in which the thermal conductivity-reducing particles are stacked along their shortest principal axes.

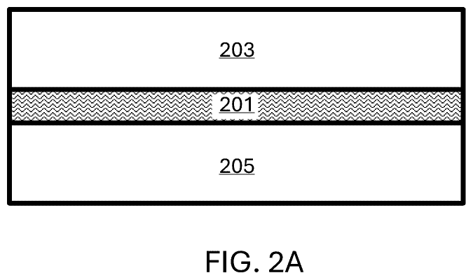

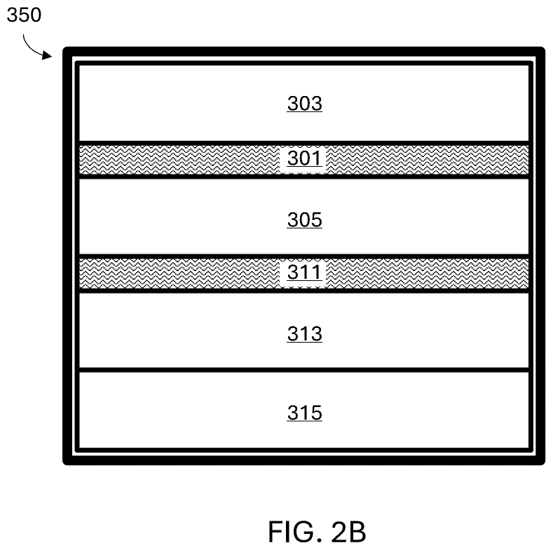

In some embodiments, a non-woven fiber web is positioned in a battery. As an example, a non-woven fiber web may be positioned between two electrochemical cells present in a battery. FIG. 2A presents a nonlimiting side-view schematic of a non-woven fiber web 201 positioned between a first electrochemical cell 203 and a second electrochemical cell 205. The non-woven fiber web 201 may directly contact at least a portion of the first electrochemical cell 203 and/or the second electrochemical cell 205, as shown in FIG. 2A, or may be separated from one or both of the electrochemical cells 203 and 205 by one or more intervening materials (not shown). For example, in some embodiments, a non-woven fiber web may be separated from an electrochemical cell by an intervening material that is able to undergo a relatively high degree of compression (e.g., a compressible foam) and/or that can accommodate dimensional changes (e.g., expansion, contraction) during charge and/or discharge of the electrochemical cell. In such embodiments, both the non-woven fiber web and the intervening material may be positioned between electrochemical cells.

In some embodiments, a non-woven fiber web is positioned in a battery comprising more than two electrochemical cells. In some such embodiments, a battery may comprise multiple non-woven fiber webs positioned between multiple pairs of electrochemical cells. FIG. 2B presents a cross-sectional schematic of a nonlimiting battery 350 comprising more than two electrochemical cells and more than one non-woven fiber web. As shown in FIG. 2B, the battery 350 comprises a first non-woven fiber web 301 (separating a first electrochemical cell 303 from a second electrochemical cell 305) and a second non-woven fiber web 311 (separating the second electrochemical cell 305 from a third electrochemical cell 313). As also shown in FIG. 2B, in some embodiments, it is possible for some pairs of nearest neighbor electrochemical cells to have a non-woven fiber web positioned therebetween and for some pairs of nearest neighbor electrochemical cells to not have a non-woven fiber web positioned therebetween. In some embodiments, non-woven fiber webs are positioned at regular intervals within a battery. For instance, non-woven fiber webs may be positioned between every other pair of nearest neighbor electrochemical cells, every third pair of nearest neighbor electrochemical cells, ever fourth pair of nearest neighbor electrochemical cells, etc. It is also possible for all of the nearest neighbor electrochemical cells in a battery to have a non-woven fiber web positioned therebetween.

As used herein, nearest neighbor electrochemical cells are electrochemical cells positioned in a common stack that are not separated by other electrochemical cells. The electrochemical cells at the end of a stack have one nearest neighbor electrochemical cell and electrochemical cells in the middle of a stack have two nearest neighbor electrochemical cells. For instance, with reference to FIG. 2B, the electrochemical cell 313 has two nearest neighbor electrochemical cells: the electrochemical cell 305 (from which it is separated by the non-woven fiber web 311) and the electrochemical cell 315 (from which it is not separated by a non-woven fiber web). As another example, and also with reference to FIG. 2B, the electrochemical cell 315 has one nearest neighbor electrochemical cell: the electrochemical cell 313.

In some embodiments, the non-woven fiber web may be adhered to one or more electrochemical cells. The non-woven fiber web being adhered to one or more of the electrochemical cells in a battery may advantageously improve the rigidity of the battery and/or dampen vibration of the battery, which may include vibrations that occur while the battery is in use. In some embodiments, the non-woven fiber web may be adhered to one or more electrochemical cells using a glue and/or an adhesive. For example, in some embodiments, the non-woven fiber web may be adhered to one or more electrochemical cells using a dispensable glue and/or a pressure-sensitive adhesive. The adhesive may be in the form of a layer (e.g., it may be an adhesive layer) or it may be in a non-layer form (e.g., it may be in the form of discrete volumes of adhesive that do not together form a layer).

In some embodiments, a battery comprises a plurality of modules. Generally, each module comprises a plurality of electrochemical cells, such as those described elsewhere herein. In some embodiments, all or a majority of the electrochemical cells of a battery are positioned in a module present in the battery. The plurality of electrochemical cells present in a module may be mechanically coupled to one another via the module. A module may comprise one or more non-woven fiber webs. Such non-woven fiber webs may be positioned between electrochemical cells present in the module. In some embodiments, a battery comprises modules that do not comprise a non-woven fiber web. For example, in some embodiments, a battery comprises no modules that comprise a non-woven fiber web. It is also possible for a battery to comprise some modules that comprise a non-woven fiber web and others that do not. For example, in some instances, every second module, every third module, or every fourth module in a battery may comprise a non-woven fiber web, while other modules do not. Other configurations are also possible.

In some embodiments, a battery may comprise both a non-woven fiber web described herein and a different type of thermal barrier material. For example, in some embodiments, a battery may comprise both a non-woven fiber web and a compression and/or fire protection material comprising a foam, a mica sheet, and/or a ceramic sheet.

When a battery comprises both a non-woven fiber web described herein and a different type of thermal barrier material, the non-woven fiber web and the thermal barrier material may be arranged as desired. In some embodiments, a non-woven fiber web may be positioned between an electrochemical cell and the different type of thermal barrier material and/or between a module and the different type of thermal barrier material. In some embodiments, the different type of thermal barrier material may be positioned between an electrochemical cell and a non-woven fiber web and/or between a module and a non-woven fiber web. In some embodiments, a non-woven fiber web may be positioned between two thermal barrier materials and/or a thermal barrier material may be positioned between two non-woven fiber webs. In some embodiments, the non-woven fiber webs and thermal barrier materials may be placed in different locations (e.g., between different pairs of nearest neighbor electrochemical cells and/or modules).

In some embodiments, a battery may comprise a thermal barrier material comprising a non-woven fiber web and further comprise an active thermal management system.

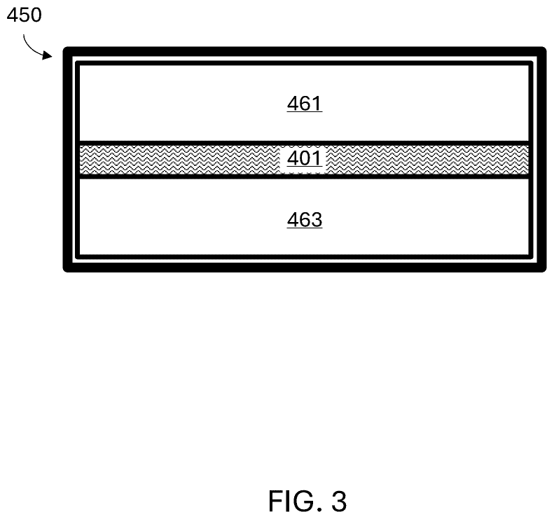

In some embodiments, a battery comprises a non-woven fiber web positioned between two modules present therein. FIG. 3 schematically shows such a battery (the battery 450). In FIG. 3, the non-woven fiber web 401 is positioned between the modules 461 and 463. The non-woven fiber web 401 may directly contact at least a portion of the first module 461 and/or the second module 463, as shown in FIG. 3, or may be separated from one or both of the modules 461 and 463 by one or more intervening materials (not shown).

A non-woven fiber web positioned between two modules present in a battery may both separate modules and separate electrochemical cells present in different modules. As one example, a non-woven fiber web positioned between two modules may, by separating the modules from each other, also separate the electrochemical cells present in the modules from each other. Such non-woven fiber webs may thereby separate a first electrochemical cell belonging to the first module from a second electrochemical cell belonging to the second module.

In some embodiments, a non-woven fiber web is positioned in a battery comprising more than two modules. In some such embodiments, a battery may comprise multiple non-woven fiber webs positioned between multiple pairs of modules. In some embodiments, it is possible for some pairs of nearest neighbor modules to have a non-woven fiber web positioned therebetween and for some pairs of nearest neighbor modules to not have a non-woven fiber web positioned therebetween. It is also possible for all of the nearest neighbor modules in a battery to have a non-woven fiber web positioned therebetween.

As used herein, nearest neighbor modules are modules positioned in a common battery that are not separated by other modules. In some embodiments, modules may be stacked to form one or more stacks. The modules at the end of a stack have one nearest neighbor module in its stack and one nearest neighbor in each stack to which it is adjacent. The modules in the middle of a stack have two nearest neighbor modules in their stacks and one nearest neighbor module in each stack to which they are adjacent. In some embodiments, a non-woven fiber web described herein may be adhered to the walls of one or more modules and/or the walls of the battery. The non-woven fiber web being adhered to the walls of one or more of the modules in a battery and/or the walls of the battery may advantageously improve the rigidity of the battery and/or dampen vibration of the battery, which may include vibrations that occur while the battery is in use. In some embodiments, the non-woven fiber web may be adhered to the walls of one or more modules and/or the walls of the battery using a glue and/or an adhesive. For example, in some embodiments, the non-woven fiber web may be adhered to the walls of one or more modules and/or the walls of the battery using a dispensable glue and/or a pressure-sensitive adhesive. The adhesive may be in the form of a layer (e.g., it may be an adhesive layer) or it may be in a non-layer form (e.g., it may be in the form of discrete volumes of adhesive that do not together form a layer).

In some embodiments, non-woven fiber webs may be disposed in a battery in a manner other than that shown in FIGS. 2A, 2B, and 3. For example, a non-woven fiber web may be folded such that a first portion of the non-woven fiber web separates a first pair of nearest neighbor electrochemical cells, and a second portion of the non-woven fiber web separates a second pair of nearest neighbor electrochemical cells. As another example, a battery may comprise a non-woven fiber web that is folded such that it winds between the electrochemical cells of the battery in a serpentine configuration. Similarly, non-woven fiber webs may be folded such that they comprise a first portion separating a first pair of nearest neighbor modules and a second portion separating a second pair of nearest neighbor modules and/or may be folded such that they wind between modules in a battery in a serpentine configuration.

In some embodiments, a non-woven fiber web is positioned external to a stack of electrochemical cells. For instance, it may be positioned adjacent to an electrochemical cell at the end of the stack of electrochemical cells and may be positioned on a side of that electrochemical cell opposite the side on which that electrochemical cell's nearest neighbor is positioned. As another example, it may be positioned on top of a stack of electrochemical cells, below a stack of electrochemical cells, and/or along a side of a stack of electrochemical cells.

In some embodiments, a non-woven fiber web is positioned external to a stack of modules. For instance, it may be positioned adjacent to a module at the end of the stack of modules and may be positioned on a side of that module opposite the side on which that module's nearest neighbor is positioned. As another example, it may be positioned on top of a stack of modules, below a stack of modules, and/or along a side of a stack of modules.

It should, of course, be understood that although battery 350 of FIG. 2B and the battery 450 of FIG. 3 have stacked configurations, generally, batteries in which a non-woven fiber web described herein is positioned may comprise electrochemical cells and modules in any of a variety of spatial configurations, such as laterally offset or wound electrochemical cell configurations, and the disclosure is not so limited.

In some embodiments, a motor vehicle (e.g. a car, a motorcycle, electric bike, three-wheeler, etc.) may comprise one or more batteries in which a non-woven fiber web described herein is positioned and/or a battery described herein may be configured and/or suitable for inclusion in a motor vehicle. In some embodiments, a consumer electronic device may comprise one or more batteries in which a non-woven fiber web described herein is positioned and/or a battery described herein may be configured and/or suitable for inclusion in a consumer electronic device. In some embodiments, a power tool may comprise one or more batteries in which a non-woven fiber web described herein is positioned and/or a battery described herein may be configured and/or suitable for inclusion in a power tool. In some embodiments, an energy storage system may comprise one or more batteries in which a non-woven fiber web described herein is positioned and/or a battery described herein may configured and/or suitable for inclusion in an energy storage system.

A non-woven fiber web described herein may comprise glass fibers. The glass fibers may be included in any of a variety of appropriate amounts. In some embodiments, a non-woven fiber web comprises glass fibers in an amount of greater than or equal to 5 wt %, greater than or equal to 10 wt %, greater than or equal to 15 wt %, greater than or equal to 20 wt %, greater than or equal to 25 wt %, greater than or equal to 30 wt %, greater than or equal to 35 wt %, greater than or equal 40 wt %, greater than or equal 45 wt %, greater than or equal 50 wt %, greater than or equal to 55 wt %, or greater than or equal to 60 wt % of the non-woven fiber web. In some embodiments, a non-woven fiber web comprises glass fibers in an amount less than or equal to 65 wt %, less than or equal to 60 wt %, less than or equal to 55 wt %, less than or equal to 50 wt %, less than or equal to 45 wt %, less than or equal to 40 wt %, less than or equal to 35 wt %, less than or equal to 30 wt %, less than or equal to 25 wt %, less than or equal to 20 wt %, less than or equal to 15 wt %, or less than or equal to 10 wt % of the non-woven fiber web. Combinations of these ranges are also possible (e.g., greater than or equal to 5 wt % and less than or equal to 65 wt %, greater than or equal to 20 wt % and less than or equal to 65 wt %, greater than 25 wt % and less than or equal to 60 wt %, or greater than or equal to 30 wt % and less than or equal to 55 wt %). Other ranges are also possible.

Glass fibers may have any of a variety of appropriate average fiber diameters. In some embodiments, a non-woven fiber web comprises glass fibers having an average diameter of greater than or equal to 0.2 micron, greater than or equal to 0.5 micron, greater than or equal to 1 micron, greater than or equal to 2 microns, greater than or equal to 3 microns, greater than or equal to 4 microns, greater than or equal to 5 microns, greater than or equal to 6 microns, greater than or equal to 7 microns, greater than or equal to 8 microns, greater than or equal to 9 microns, or greater than or equal to 10 microns. In some embodiments, a non-woven fiber web comprises glass fibers having an average diameter of less than or equal to 13 microns, less than or equal to 10 microns, less than or equal to 9 microns, less than or equal to 8 microns, less than or equal to 7 microns, less than or equal to 6 microns, less than or equal to 5 microns, less than or equal to 4 microns, less than or equal to 3 microns, less than or equal to 2 microns, less than or equal to 1 micron, or less than or equal to 0.5 micron. Combinations of these ranges are also possible (e.g., greater than or equal to 0.2 microns and less than or equal to 13 microns, greater than or equal to 0.5 microns and less than or equal to 10 microns, greater than or equal to 1 micron and less than or equal to 8 microns, or greater than 2 microns and less than 6 microns). Other ranges are also possible.

A non-woven fiber web described herein may comprise glass fibers having any of a variety of suitable average lengths. In some embodiments, a non-woven fiber web comprises glass fibers having an average length of greater than or equal to 0.2 mm, greater than or equal to 0.5 mm, greater than or equal to 1 mm, greater than or equal to 1.5 mm, greater than or equal to 2 mm, greater than or equal to 3 mm, greater than or equal to 4 mm, greater than or equal to 5 mm, greater than or equal to 6 mm, greater than or equal to 7 mm, greater than or equal to 8 mm, greater than or equal to 9 mm, or greater than or equal to 10 mm. In some embodiments, a non-woven fiber web comprises glass fibers having an average length of less than or equal to 13 mm, less than or equal to 10 mm, less than or equal to 9 mm, less than or equal to 8 mm, less than or equal to 7 mm, less than or equal to 6 mm, less than or equal to 5 mm, less than or equal to 4 mm, less than or equal to 3 mm, less than or equal to 2 mm, less than or equal to 1.5 mm, less than or equal to 1 mm, or less than or equal to 0.5 mm. Combinations of these ranges are also possible (e.g., greater than or equal to 0.2 mm and less than or equal to 13 mm, greater than or equal to 1 mm and less than or equal to 10 mm, greater than or equal to 1.5 mm and less than or equal to 8 mm, or greater than 2 mm and less than or equal to 6 mm). Other ranges are also possible.

This disclosure recognizes that some glass fibers, such as those having high thermal stability (referred to herein as high softening point fibers), may provide a number of advantages when incorporated into non-woven fiber webs for use in thermal insulation materials. For example, high softening point fibers may be less prone to softening and/or shrinkage upon heating, as described in greater detail below. High softening point fibers may comprise silicate, alumina, or aluminosilicate glasses with any of a variety of suitable chemical compositions.

In some embodiments, a non-woven fiber web comprises high softening point fibers in an amount of greater than or equal to 5 wt %, greater than or equal to 10 wt %, greater than or equal to 15 wt %, greater than or equal to 20 wt %, greater than or equal to 25 wt %, greater than or equal to 30 wt %, or greater than or equal to 35 wt % of the non-woven fiber web. In some embodiments, a non-woven fiber web comprises glass fibers in an amount less than or equal to 40 wt %, less than or equal to 35 wt %, less than or equal to 30 wt %, less than or equal to 25 wt %, less than or equal to 20 wt %, less than or equal to 15 wt %, or less than or equal to 10 wt % of the non-woven fiber web. Combinations of these ranges are also possible (e.g., greater than or equal to 5 wt % and less than or equal to 40 wt %, or greater than or equal to 15 wt % and less than or equal to 30 wt %). Other ranges are also possible.

The present disclosure recognizes that, in accordance with some embodiments, it may be advantageous for high softening point fibers to comprise relatively small amounts of alkali metal oxides, such as sodium oxides and/or potassium oxides. Without wishing to be bound by any particular theory, sodium and potassium may disrupt a network of covalent bonds within aluminosilicate glasses, thereby reducing their thermal stability and their softening point. In some embodiments, Na₂O is present in a high softening point fiber in an amount of less than or equal to 0.8 wt %, less than or equal to 0.7 wt %, less than or equal to 0.6 wt %, less than or equal to 0.5 wt %, less than or equal to 0.4 wt %, or less than or equal to 0.3 wt % versus the total weight of the high softening point fiber. In some embodiments, Na₂O is present in a high softening point fiber in an amount of greater than or equal to 0.1 wt %, greater than or equal to 0.2 wt %, greater than or equal to 0.3 wt %, greater than or equal to 0.4 wt %, greater than or equal to 0.5 wt %, or greater than or equal to 0.6 wt % versus the total weight of the high softening point fiber. Combinations of these ranges are also possible (e.g., greater than or equal to 0.1 wt % and less than or equal to 0.8 wt %, greater than or equal to 0.1 wt % and less than or equal to 0.6 wt %, or greater than or equal to 0.1 wt % and less than or equal to 0.5 wt % versus the total weight of the high softening point fiber). Other ranges are also possible.

In some embodiments, K₂O is present in a high softening point fiber in an amount of less than or equal to 0.8 wt %, less than or equal to 0.75 wt %, less than or equal to 0.7 wt %, less than or equal to 0.65 wt %, less than or equal to 0.6 wt %, less than or equal to 0.55 wt %, less than or equal to 0.5 wt %, less than or equal to 0.45 wt %, or less than or equal to 0.4 wt % versus the total weight of the high softening point fiber. In some embodiments, K₂O is present in a high softening point fiber in an amount of greater than or equal to 0 wt % greater than or equal to 0.05 wt %, greater than or equal to 0.1 wt %, greater than or equal to 0.15 wt %, greater than or equal to 0.2 wt %, greater than or equal to 0.25 wt %, or greater than or equal to 0.3 wt % versus the total weight of the high softening point fiber. Combinations of these ranges are also possible (e.g., greater than or equal to 0 wt % and less than or equal to 0.8 wt %, greater than or equal to 0.05 wt % and less than or equal to 0.6 wt %, or greater than or equal to 0.05 wt % and less than or equal to 0.5 wt % versus the total weight of the high softening point fiber). Other ranges are also possible. In some embodiments, K₂O is present in a high softening point fiber in an amount of 0 wt %.

Relatively low amounts of boron may be associated with advantageously high softening points. A non-woven fiber web may comprise a high softening point fiber having any of a variety of suitable amounts of B₂O₃. In some embodiments, B₂O₃ is present in a high softening point fiber in an amount of less than or equal to 10 wt %, less than or equal to 9 wt %, less than or equal to 8 wt %, less than or equal to 7 wt %, less than or equal to 6 wt %, less than or equal to 5 wt %, less than or equal to 4 wt %, less than or equal to 3 wt %, or less than or equal to 2 wt % versus the total weight of the high softening point fiber. In some embodiments, B₂O₃ is present in a high softening point fiber in an amount of greater than or equal to 0 wt %, greater than or equal to 1 wt %, greater than or equal to 2 wt %, greater than or equal to 3 wt %, or greater than or equal to 4 wt % versus the total weight of the high softening point fiber. Combinations of these ranges are also possible (e.g., greater than or equal to 0 wt % and less than or equal to 10 wt %, greater than or equal to 0 wt % and less than or equal to 7 wt %, or greater than or equal to 0 wt % and less than or equal to 2 wt % versus the total weight of the high softening point fiber). Other ranges are also possible. In some embodiments, B₂O₃ is present in a high softening point fiber in an amount of 0 wt %.

In some embodiments, high softening point fibers may comprise glasses of the types commercially known as E-glass or ECR-glass. Further details regarding possible compositions for high softening point fibers are provided below.

A high softening point fiber, such as an E-glass fiber or an ECR-glass fiber may comprise any of a variety of compounds. For example, a non-woven fiber web may comprise a high softening point fiber having any of a variety of suitable amounts of SiO₂. In some embodiments, SiO₂ is present in a high softening point fiber in an amount of greater than or equal to 50 wt %, greater than or equal to 51 wt %, greater than or equal to 52 wt %, greater than or equal to 53 wt %, greater than or equal to 54 wt %, greater than or equal to 55 wt %, greater than or equal to 56 wt %, greater than or equal to 57 wt %, greater than or equal to 58 wt %, greater than or equal to 59 wt %, greater than or equal to 60 wt %, greater than or equal to 61 wt %, greater than or equal to 62 wt %, greater than or equal to 63 wt %, greater than or equal to 64 wt %, greater than or equal to 65 wt %, greater than or equal to 66 wt %, greater than or equal to 67 wt %, greater than or equal to 68 wt %, or greater than or equal to 69 wt % versus the total weight of the high softening point fiber. In some embodiments, SiO₂ is present in the high softening point fiber in an amount of less than or equal to 70 wt %, less than or equal to 69 wt %, less than or equal to 68 wt %, less than or equal to 67 wt %, less than or equal to 66 wt %, less than or equal to 65 wt %, less than or equal to 64 wt %, less than or equal to 63 wt %, less than or equal to 62 wt %, less than or equal to 61 wt %, or less than or equal to 60 wt % versus the total weight of the high softening point fiber. Combinations of these ranges are also possible (e.g., greater than or equal to 50 wt % and less than or equal to 70 wt %, greater than or equal to 50 wt % and less than or equal to 65 wt %, greater than or equal to 55 wt % and less than or equal to 64 wt %, or greater than or equal to 60 wt % and less than or equal to 64 wt % versus the total weight of the high softening point fiber). Other ranges are also possible.

A non-woven fiber web may comprise a high softening point fiber having any of a variety of suitable amounts of Al₂O₃. In some embodiments, Al₂O₃ is present in a high softening point fiber in an amount of greater than or equal to 6 wt %, greater than or equal to 7 wt %, greater than or equal to 8 wt %, greater than or equal to 9 wt %, greater than or equal to 10 wt %, or greater than or equal to 11 wt % versus the total weight of the high softening point fiber. In some embodiments, Al₂O₃ is present in a high softening point fiber in an amount of less than or equal to 16 wt %, less than or equal to 15 wt %, less than or equal to 14 wt %, less than or equal to 13 wt %, less than or equal to 12 wt %, or less than or equal to 11 wt % versus the total weight of the high softening point fiber. Combinations of these ranges are also possible (e.g., greater than or equal to 6 wt % and less than or equal to 16 wt %, greater than or equal to 8 wt % and less than or equal to 15 wt %, or greater than or equal to 10 wt % and less than or equal to 14 wt % versus the total weight of the high softening point fiber). Other ranges are also possible.

A non-woven fiber web may comprise a high softening point fiber having any of a variety of suitable amounts of CaO. In some embodiments, CaO is present in a high softening point fiber in an amount of greater than or equal to 15 wt %, greater than or equal to 16 wt %, greater than or equal to 17 wt %, greater than or equal to 18 wt %, greater than or equal to 19 wt %, or greater than or equal to 20 wt % versus the total weight of the high softening point fiber. In some embodiments, CaO is present in a high softening point fiber in an amount of less than or equal to 25 wt %, less than or equal to 24 wt %, less than or equal to 23 wt %, less than or equal to 22 wt %, less than or equal to 21 wt %, or less than or equal to 20 wt % versus the total weight of the high softening point fiber. Combinations of these ranges are also possible (e.g., greater than or equal to 15 wt % and less than or equal to 25 wt %, greater than or equal to 17 wt % and less than or equal to 23 wt %, or greater than or equal to 19 wt % and less than or equal to 21 wt % versus the total weight of the high softening point fiber). Other ranges are also possible.

A non-woven fiber web may comprise a high softening point fiber having any of a variety of suitable amounts of MgO. In some embodiments, MgO is present in a high softening point fiber in an amount of greater than or equal to 0 wt %, greater than or equal to 0.1 wt %, greater than or equal to 0.2 wt %, greater than or equal to 0.5 wt %, greater than or equal to 1 wt %, or greater than or equal to 2 wt % versus the total weight of the high softening point fiber. In some embodiments, MgO is present in a high softening point fiber in an amount of less than or equal to 5 wt %, less than or equal to 4.5 wt %, less than or equal to 4 wt %, less than or equal to 3.5 wt %, less than or equal to 3 wt %, less than or equal to 2.5 wt %, or less than or equal to 2 wt % versus the total weight of the high softening point fiber. Combinations of these ranges are also possible (e.g., greater than or equal to 0 wt % and less than or equal to 5 wt %, greater than or equal to 0.1 wt % and less than or equal to 4 wt %, or greater than or equal to 0.2 wt % and less than or equal to 2.5 wt % versus the total weight of the high softening point fiber). Other ranges are also possible. In some embodiments, MgO is present in a high softening point fiber in an amount of 0 wt %.

A non-woven fiber web may comprise a high softening point fiber having any of a variety of suitable amounts of ZnO. In some embodiments, ZnO is present in a high softening point fiber in an amount of greater than or equal to 0 wt %, greater than or equal to 0.1 wt %, greater than or equal to 0.2 wt %, greater than or equal to 0.3 wt %, greater than or equal to 0.4 wt %, or greater than or equal to 0.5 wt % versus the total weight of the high softening point fiber. In some embodiments, ZnO is present in a high softening point fiber in an amount of less than or equal to 1 wt %, less than or equal to 0.9 wt %, less than or equal to 0.8 wt %, less than or equal to 0.7 wt %, less than or equal to 0.6 wt %, less than or equal to 0.5 wt %, less than or equal to 0.4 wt %, less than or equal to 0.3 wt %, or less than or equal to 0.2 wt % versus the total weight of the high softening point fiber. Combinations of these ranges are also possible (e.g., greater than or equal to 0 wt % and less than or equal to 1 wt %, greater than or equal to 0 wt % and less than or equal to 0.5 wt %, or greater than or equal to 0 wt % and less than or equal to 0.2 wt % versus the total weight of the high softening point fiber). Other ranges are also possible. In some embodiments, ZnO is present in a high softening point fiber in an amount of 0 wt %.

A non-woven fiber web may comprise a high softening point fiber having any of a variety of suitable amounts of TiO₂. In some embodiments, TiO₂ is present in a high softening point fiber in an amount of greater than or equal to 0.2 wt %, greater than or equal to 0.3 wt %, greater than or equal to 0.4 wt %, greater than or equal to 0.5 wt %, greater than or equal to 0.8 wt %, or greater than or equal to 1 wt % versus the total weight of the high softening point fiber. In some embodiments, TiO₂ is present in a high softening point fiber in an amount of less than or equal to 2.5 wt %, less than or equal to 2.2 wt %, less than or equal to 2 wt %, less than or equal to 1.8 wt %, less than or equal to 1.5 wt %, less than or equal to 1.2 wt %, less than or equal to 1 wt %, less than or equal to 0.8 wt %, or less than or equal to 0.5 wt % versus the total weight of the high softening point fiber. Combinations of these ranges are also possible (e.g., greater than or equal to 0.2 wt % and less than or equal to 2.5 wt %, greater than or equal to 0.2 wt % and less than or equal to 1 wt %, or greater than or equal to 0.2 wt % and less than or equal to 0.5 wt % versus the total weight of the high softening point fiber). Other ranges are also possible.

A non-woven fiber web may comprise a high softening point fiber having any of a variety of suitable amounts of Fe₂O₃. In some embodiments, Fe₂O₃ is present in a high softening point fiber in an amount of greater than or equal to 0 wt %, greater than or equal to 0.1 wt %, greater than or equal to 0.2 wt %, greater than or equal to 0.3 wt %, or greater than or equal to 0.4 wt % versus the total weight of the high softening point fiber. In some embodiments, Fe₂O₃ is present in a high softening point fiber in an amount of less than or equal to 0.5 wt %, less than or equal to 0.4 wt %, less than or equal to 0.3 wt %, or less than or equal to 0.2 wt % versus the total weight of the high softening point fiber. Combinations of these ranges are also possible (e.g., greater than or equal to 0 wt % and less than or equal to 0.5 wt %, greater than or equal to 0 wt % and less than or equal to 0.4 wt %, or greater than or equal to 0 wt % and less than or equal to 0.3 wt % versus the total weight of the high softening point fiber). Other ranges are also possible. In some embodiments, Fe₂O₃ is present in a high softening point fiber in an amount of 0 wt %.

A non-woven fiber web may comprise a high softening point fiber having any of a variety of suitable amounts of F. In some embodiments, F is present in a high softening point fiber in an amount of greater than or equal to 0 wt %, greater than or equal to 0.01 wt %, greater than or equal to 0.02 wt %, greater than or equal to 0.05 wt %, greater than or equal to 0.075 wt %, greater than or equal to 0.1 wt %, greater than or equal to 0.15 wt %, greater than or equal to 0.2 wt %, or greater than or equal to 0.25 wt % versus the total weight of the high softening point fiber. In some embodiments, F is present in a high softening point fiber in an amount of less than or equal to 0.3 wt %, less than or equal to less than or equal to 0.25 wt %, less than or equal to 0.2 wt %, less than or equal to 0.15 wt %, less than or equal to 0.075 wt %, less than or equal to 0.05 wt %, less than or equal to 0.02 wt %, or less than or equal to 0.01 wt % versus the total weight of the high softening point fiber. Combinations of these ranges are also possible (e.g., greater than or equal to 0 wt % and less than or equal to 0.3 wt %). Other ranges are also possible. In some embodiments, F is present in a high softening point fiber in an amount of 0 wt %.

A non-woven fiber web described herein may comprise high softening point fibers having any of a variety of suitable softening points. In some embodiments, a non-woven fiber web comprises high softening point fibers having a softening point of greater than or equal to 800° C., greater than or equal to 825° C., greater than or equal to 850° C., greater than or equal to 875° C., greater than or equal to 900° C., greater than or equal to 925° C., or greater than or equal to 950° C. In some embodiments, a non-woven fiber web comprises high softening point fibers having a softening point of less than or equal to 1,000° C., less than or equal to 975° C., less than or equal to 950° C., less than or equal to 925° C., or less than or equal to 900° C. Combinations of these ranges are also possible (e.g., greater than or equal to 800° C. and less than or equal to 1,000° C., greater than or equal to 850° C. and less than or equal to 1,000° C., or greater than or equal to 900° C. and less than or equal to 1,000° C.). Other ranges are also possible. The softening point of high softening point fibers may be determined in accordance with ASTM C338-1993.

In some embodiments, a non-woven fiber web comprises chopped strand glass fibers. The chopped strand glass fibers may comprise chopped strand glass fibers which were produced by drawing a melt of glass from bushing tips into continuous fibers and then cutting the continuous fibers into short fibers. Some chopped strand glass fibers may comprise fibers that have relatively monodispersed fiber diameters and/or may comprise two or more populations of fibers that each have relatively monodispersed fiber diameters. Some chopped strand glass fibers may be relatively straight. In some embodiments, chopped strand glass fibers are provided (e.g., to a furnish) in the form that is relatively unentangled.

In some embodiments, a non-woven fiber web comprises chopped strand glass fibers that are high softening point fibers. It is also possible for a non-woven fiber web to comprise chopped strand glass fibers that are not high softening point fibers. It should be understood that chopped strand glass fibers present in a non-woven fiber web may comprise one or more of the types of chopped strand glass fibers described herein.

A non-woven fiber web comprises chopped strand glass fibers in any of a variety of suitable amounts. In some embodiments, a non-woven fiber web comprises chopped strand glass fibers in an amount of greater than or equal to 5 wt %, greater than or equal to 7.5 wt %, greater than or equal to 10 wt %, greater than or equal to 12.5 wt %, greater than or equal to 15 wt %, greater than or equal to 17.5 wt %, greater than or equal to 20 wt %, greater than or equal to 22.5 wt %, greater than or equal to 25 wt %, greater than or equal to 27.5 wt %, greater than or equal to 30 wt %, greater than or equal to 32.5 wt %, greater than or equal to 35 wt %, or greater than or equal to 37.5 wt % of the non-woven fiber web. In some embodiments, a non-woven fiber web comprises chopped strand glass fibers in an amount of less than or equal to 40 wt %, less than or equal to 37.5 wt %, less than or equal to 35 wt %, less than or equal to 32.5 wt %, less than or equal to 30 wt %, less than or equal to 27.5 wt %, less than or equal to 25 wt %, less than or equal to 22.5 wt %, less than or equal to 20 wt %, less than or equal to 17.5 wt %, less than or equal to 15 wt %, less than or equal to 12.5 wt %, or less than or equal to 10 wt % of the non-woven fiber web. Combinations of these ranges are also possible (e.g., greater than or equal to 5 wt % and less than or equal to 40 wt %, greater than or equal to 10 wt % and less than or equal to 35 wt %, or greater than or equal to 15 wt % and less than or equal to 30 wt %). Other ranges are also possible.

A non-woven fiber web may comprise chopped strand glass fibers of any of a variety of suitable diameters. In some embodiments, a non-woven fiber web may comprise chopped strand glass fibers having an average diameter of greater than or equal to 3 microns, greater than or equal to 4 microns, greater than or equal to 5 microns, greater than or equal to 6 microns, greater than or equal to 7 microns, greater than or equal to 8 microns, greater than or equal to 9 microns, greater than or equal to 10 microns, greater than or equal to 11 microns, or greater than or equal to 12 microns. In some embodiments, a non-woven fiber web may comprise chopped strand glass fibers having an average diameter of less than or equal to 13 microns, less than or equal to 12 microns, less than or equal to 11 microns, less than or equal to 10 microns, less than or equal to 9 microns, less than or equal to 8 microns, less than or equal to 7 microns, less than or equal to 6 microns, less than or equal to 5 microns, or less than or equal to 4 microns. Combinations of these ranges are also possible (e.g., greater than or equal to 3 microns and less than or equal to 13 microns, greater than or equal to 4 microns and less than or equal to 11 microns, or greater than or equal to 5 microns and less than or equal to 9 microns). Other ranges are also possible.

A non-woven fiber web may comprise chopped strand glass fibers of any of a variety of suitable lengths. In some embodiments, a non-woven fiber web may comprise chopped strand glass fibers having an average length of greater than or equal to 3 mm, greater than or equal to 4 mm, greater than or equal to 5 mm, greater than or equal to 6 mm, greater than or equal to 7 mm, greater than or equal to 8 mm, greater than or equal to 10 mm, greater than or equal to 11 mm, or greater than or equal to 12 mm. In some embodiments, a non-woven fiber web may comprise chopped strand glass fibers having an average length of less than or equal to 13 mm, less than or equal to 12 mm, less than or equal to 11 mm, less than or equal to 10 mm, less than or equal to 9 mm, less than or equal to 8 mm, less than or equal to 7 mm, less than or equal to 6 mm, less than or equal to 5 mm, or less than or equal to 4 mm. Combinations of these ranges are also possible (e.g., greater than or equal to 3 mm and less than or equal to 13 mm, greater than or equal to 4 mm and less than or equal to 10 mm, or greater than or equal to 5 mm and less than or equal to 7 mm). Other ranges are also possible.

A non-woven fiber web may comprise microglass fibers. In some embodiments, a non-woven fiber web may comprise microglass fibers having any of a variety of suitable compositions. For instance, it is possible for a non-woven fiber web to comprise microglass fibers that are high softening point fibers and/or microglass fibers that are not high softening point fibers. Non-limiting examples of microglass fibers include B glass fibers, E glass fibers, S glass fibers, M glass fibers according to Man Made Vitreous Fibers by Nomenclature Committee of TIMA Inc. March 1993, Page 45, C glass fibers (e.g., Lauscha C glass fibers, JM 253 C glass fibers), and non-persistent glass fibers (e.g., fibers that are configured to dissolve completely in the fluid present in human lungs in less than or equal to 40 days, such as Johns Manville 481 fibers).

In some embodiments, the non-woven fiber web may comprise microglass fibers in an amount of greater than or equal to 0.1 wt %, less than or equal to 0.25 wt %, greater than or equal to 0.5 wt %, greater than or equal to 0.75 wt %, greater than or equal to 1 wt %, greater than or equal to 2.5 wt %, greater than or equal to 5 wt %, greater than or equal to 7.5 wt %, greater than or equal to 10 wt %, greater than or equal to 12.5 wt %, greater than or equal to 15 wt %, greater than or equal to 17.5 wt %, greater than or equal to 20 wt %, greater than or equal to 22.5 wt %, greater than or equal to 25 wt %, greater than or equal to 27.5 wt %, greater than or equal to 30 wt %, or greater than or equal to 32.5 wt % of the non-woven fiber web. In some embodiments, the non-woven fiber web may comprise microglass fibers in an amount of less than or equal to 35 wt %, less than or equal to 32.5 wt %, less than or equal to 30 wt %, less than or equal to 27.5 wt %, less than or equal to 25 wt %, less than or equal to 22.5 wt %, less than or equal to 20 wt %, less than or equal to 17.5 wt %, less than or equal to 15 wt %, less than or equal to 12.5 wt %, less than or equal to 10 wt %, less than or equal to 7.5 wt %, less than or equal to 5 wt %, less than or equal to 2.5 wt %, less than or equal to 1 wt %, less than or equal to 0.75 wt %, less than or equal to 0.5 wt %, or less than or equal to 0.25 wt % of the non-woven fiber web. Combinations of these ranges are also possible (e.g., greater than or equal to 0.1 wt % and less than or equal to 35 wt %, greater than or equal to 0.5 wt % and less than or equal to 30 wt %, or greater than or equal to 10 wt % and less than or equal to 25 wt %). Other ranges are also possible. In some embodiments, the non-woven fiber web may be substantially free of microglass fibers (e.g., in some embodiments, the non-woven fiber web may comprise no microglass fibers or only trace amounts of microglass fibers).

In some embodiments, the non-woven fiber web may comprise microglass fibers of any of a variety of suitable diameters. In some embodiments, the non-woven fiber web may comprise microglass fibers having an average diameter of greater than or equal to 0.2 micron, greater than or equal to 0.5 micron, greater than or equal to 0.8 micron, greater than or equal to 1 micron, greater than or equal to 1.5 microns, greater than or equal to 2 microns, greater than or equal to 2.5 microns, greater than or equal to 3 microns, greater than or equal to 3.5 microns, greater than or equal to 4 microns, greater than or equal to 4.5 microns, greater than or equal to 5 microns, greater than or equal to 5.5 microns, greater than or equal to 6 microns, greater than or equal to 6.5 microns, greater than or equal to 7 microns, or greater than or equal to 7.5 microns. In some embodiments, the non-woven fiber web may comprise microglass fibers having an average diameter of less than or equal to 8 microns, less than or equal to 7.5 microns, less than or equal to 7 microns, less than or equal to 6.5 microns, less than or equal to 6 microns, less than or equal to 5.5 microns, less than or equal to 5 microns, less than or equal to 4.5 microns, less than or equal to 4 microns, less than or equal to 3.5 microns, less than or equal to 3 microns, less than or equal to 2.5 microns, less than or equal to 2 microns, less than or equal to 1.5 microns, less than or equal to 1 micron, or less than or equal to 0.8 micron. Combinations of these ranges are also necessary (e.g., greater than or equal to 0.2 micron and less than or equal to 8 microns, greater than or equal to 0.5 micron and less than or equal to 6 microns, or greater or equal to than 1 micron or less than or equal to 3 microns). Other combinations are also possible.

In some embodiments, the non-woven fiber web may comprise microglass fibers of any of a variety of suitable lengths. In some embodiments, the non-woven fiber web may comprise microglass fibers having an average length of greater than or equal to 0.2 mm, greater than or equal to 0.3 mm, greater than or equal to 0.4 mm, greater than or equal to 0.5 mm, greater than or equal to 0.6 mm, greater than or equal to 0.7 mm, greater than or equal to 0.8 mm, greater than or equal to 0.9 mm, greater than or equal to 1 mm, greater than or equal to 1.1 mm, greater than or equal to 1.2 mm, greater than or equal to 1.3 mm, greater than or equal to 1.4 mm, greater than or equal to 1.5 mm, greater than or equal to 1.6 mm, greater than or equal to 1.7 mm, greater than or equal to 1.8 mm, or greater than or equal to 1.9 mm. In some embodiments, the non-woven fiber web may comprise microglass fibers having an average length of less than or equal to 2 mm, less than or equal to 1.9 mm, less than or equal to 1.8 mm, less than or equal to 1.7 mm, less than or equal to 1.6 mm, less than or equal to 1.5 mm, less than or equal to 1.4 mm, less than or equal to 1.3 mm, or less than or equal to 1.2 mm, less than or equal to 1.1 mm, less than or equal to 1 mm, less than or equal to 0.9 mm, less than or equal to 0.8 mm, less than or equal to 0.7 mm, less than or equal to 0.6 mm, less than or equal to 0.5 mm, less than or equal to 0.4 mm, or less than or equal to 0.3 mm. Combinations of these ranges are also possible (e.g., greater than or equal to 0.2 mm and less than or equal to 2 mm, greater than or equal to 0.4 mm and less than or equal to 1.5 mm, or greater than or equal to 0.6 mm and less than or equal to 0.8 mm).

The present disclosure recognizes advantages to including other fibers, in addition to glass fibers or instead of glass fibers, within non-woven fiber webs suitable for use as thermal barrier materials. The additional fibers may provide a number of advantages, including improved processability of a non-woven fiber web and/or improved adhesion between glass fibers in a non-woven fiber web comprising glass fibers and/or improved adhesion between glass fibers and other components in a non-woven web comprising glass fibers. The inclusion of additional fibers may, for example, reduce the thermal conductivity and/or the air permeability of a non-woven fiber web, and/or improve one or more other thermal and/or structural properties of a non-woven fiber web.

One example of a type of fiber that may be present in a non-woven web described herein is a synthetic fiber. A variety of suitable types of synthetic fibers may be employed in the non-woven fiber webs described herein. In some embodiments, a non-woven fiber web comprises synthetic fibers that are binder fibers. In such embodiments, the binder fibers comprise monocomponent binder fibers and/or multicomponent fibers (e.g., bicomponent fibers, tricomponent fibers, or fibers comprising four or more components). It is also possible for a non-woven fiber web to comprise synthetic fibers other than binder fibers, such as synthetic fibers that are chopped strand fibers and/or staple fibers.

A non-woven fiber web may comprise synthetic fibers in any of a variety of suitable amounts. In some embodiments, a non-woven fiber web may comprise synthetic fibers in an amount of greater than or equal to 0.25 wt %, greater than or equal to 0.5 wt %, greater than or equal to 1 wt %, greater than or equal to 2 wt %, greater than or equal to 2.5 wt %, greater than or equal to 3 wt %, greater than or equal to 5 wt %, greater than or equal to 8 wt %, greater than or equal to 10 wt %, greater than or equal to 11 wt %, greater than or equal to 14 wt %, greater than or equal to 15 wt %, greater than or equal to 20 wt %, greater than or equal to 25 wt %, greater than or equal to 30 wt %, greater than or equal to 35 wt %, greater than or equal to 40 wt %, greater than or equal to 45 wt %, greater than or equal to 50 wt %, or greater than or equal to 55 wt % of the non-woven fiber web. In some embodiments, a non-woven fiber web may comprise synthetic fibers in an amount of less than or equal to 60 wt %, less than or equal to 55 wt %, less than or equal to 50 wt %, less than or equal to 45 wt %, less than or equal to 40 wt %, less than or equal to 35 wt %, less than or equal to 30 wt %, less than or equal to 25 wt %, less than or equal to 20 wt %, less than or equal to 15 wt %, less than or equal to 14 wt %, less than or equal to 11 wt %, less than or equal to 10 wt %, less than or equal to 8 wt %, less than or equal to 5 wt %, less than or equal to 3 wt %, less than or equal to 2.5 wt %, or less than or equal to 2 wt % of the non-woven fiber web. Combinations of these ranges are also possible (e.g., greater than or equal to 1 wt % and less than or equal to 60 wt %, greater than or equal to 1 wt % and less than or equal to 14 wt %, greater than or equal to 2 wt % and less than or equal to 11 wt %, or greater than or equal to 3 wt % and less than or equal to 8 wt %). Other ranges are also possible.

A non-woven fiber web may comprise synthetic fibers having an of a variety of suitable diameters. In some embodiments, the non-woven fiber web comprises synthetic fibers having an average diameter of greater than or equal to 3 microns, greater than or equal to 4 microns, greater than or equal to 5 microns, greater than or equal to 6 microns, greater than or equal to 7 microns, greater than or equal to 8 microns, greater than or equal to 9 microns, greater than or equal to 10 microns, greater than or equal to 11 microns, greater than or equal to 12 microns, greater than or equal to 13 microns, greater than or equal to 14 microns, greater than or equal to 15 microns, greater than or equal to 16 microns, greater than or equal to 17 microns, greater than or equal to 18 microns, or greater than or equal to 19 microns. In some embodiments, the non-woven fiber web may comprise synthetic fibers having an average diameter of less than or equal to 20 microns, less than or equal to 19 microns, less than or equal to 18 microns, less than or equal to 17 microns, less than or equal to 16 microns, less than or equal to 15 microns, less than or equal to 14 microns, less than or equal to 13 microns, less than or equal to 12 microns, less than or equal to 11 microns, less than or equal to 10 microns, less than or equal to 9 microns, less than or equal to 8 microns, less than or equal to 7 microns, less than or equal to 6 microns, less than or equal to 5 microns, or less than or equal to 4 microns. Combinations of these ranges are also possible (e.g., greater than or equal to 3 microns and less than or equal to 20 microns, greater than or equal to 4 microns and less than or equal to 16 microns, greater than or equal to 6 microns and less than or equal to 14 microns, or greater than or equal to 8 microns and less than or equal to 12 microns). Other ranges are also possible.

A non-woven fiber web may comprise synthetic fibers having any of a variety of suitable lengths. In some embodiments, the non-woven fiber web comprises synthetic fibers having an average length of greater than or equal to 1 mm, greater than or equal to 1.5 mm, greater than or equal to 2 mm, greater than or equal to 2.5 mm, greater than or equal to 3 mm, greater than or equal to 3.5 mm, greater than or equal to 4 mm, greater than or equal to 4.5 mm, greater than or equal to 5 mm, greater than or equal to 5.5 mm, greater than or equal to 6 mm, greater than or equal to 6.5 mm, greater than or equal to 7 mm, greater than or equal to 7.5 mm, greater than or equal to 8 mm, greater than or equal to 8.5 mm, greater than or equal to 9 mm, greater than or equal to 9.5 mm, greater than or equal to 10 mm, greater than or equal to 10.5 mm, greater than or equal to 11 mm, greater than or equal to 11.5 mm, greater than or equal to 12 mm, or greater than or equal to 12.5 mm. In some embodiments, the non-woven fiber web may comprise synthetic fibers having an average length of less than or equal to 13 mm, less than or equal to 12.5 mm, less than or equal to 12 mm, less than or equal to 11.5 mm, less than or equal to 11 mm, less than or equal to 10.5 mm, less than or equal to 10 mm, less than or equal to 9.5 mm, less than or equal to 9 mm, less than or equal to 8.5 mm, less than or equal to 8 mm, less than or equal to 7.5 mm, less than or equal to 7 mm, less than or equal to 6.5 mm, less than or equal to 6 mm, less than or equal to 5.5 mm, less than or equal to 5 mm, less than or equal to 4.5 mm, less than or equal to 4 mm, less than or equal to 3.5 mm, less than or equal to 3 mm, less than or equal to 2.5 mm, less than or equal to 2 mm, or less than or equal to 1.5 mm. Combinations of these ranges are also possible (e.g., greater than or equal to 1 mm and less than or equal to 13 mm, greater than or equal to 2 mm and less than or equal to 10 mm, greater than or equal to 3 mm and less than or equal to 8 mm, or greater than or equal to 4 mm and less than or equal to 6 mm). Other ranges are also possible.

In some embodiments, a non-woven fiber web may comprise synthetic fibers which are fibrillated synthetic fibers. A fibrillated fiber includes a parent fiber that branches into smaller diameter fibrils, which can, in some instances, branch further out into even smaller diameter fibrils with further branching also being possible. The branched nature of the fibrils leads to a non-woven fiber web having a high surface area and can increase the number of contact points between the fibrillated fibers and other fibers and/or components (e.g., thermal conductivity-reducing particles) in the non-woven fiber web. Such an increase in points of contact between the fibrillated fibers and other fibers and/or components of the non-woven fiber web may contribute to enhancing mechanical properties (e.g., flexibility, strength) and/or thermal insulating performance properties of the non-woven fiber web.

A non-woven fiber web may comprise fibrillated synthetic fibers in any of a variety of suitable amounts. In some embodiments, the non-woven fiber web comprises fibrillated synthetic fibers in an amount of greater than or equal to 2 wt %, greater than or equal to 4 wt %, greater than or equal to 6 wt %, greater than or equal to 8 wt %, greater than or equal to 10 wt %, greater than or equal to 12 wt %, greater than or equal to 14 wt %, greater than or equal to 16 wt %, greater than or equal to 18 wt %, greater than or equal to 20 wt %, greater than or equal to 22 wt %, greater than or equal to 24 wt %, greater than or equal to 26 wt %, or greater than or equal to 28 wt %. In some embodiments, the non-woven fiber web comprises fibrillated synthetic fibers in an amount of less than or equal to 30 wt %, less than or equal to 28 wt %, less than or equal to 26 wt %, less than or equal to 24 wt %, less than or equal to 22 wt %, less than or equal to 20 wt %, less than or equal to 18 wt %, less than or equal to 16 wt %, less than or equal to 14 wt %, less than or equal to 12 wt %, less than or equal to 10 wt %, less than or equal to 8 wt %, less than or equal to 6 wt %, or less than or equal to 4 wt %. Combinations of these ranges are also possible (e.g., the non-woven fiber web may comprise fibrillated synthetic fibers in an amount greater than or equal to 2 wt % and less than or equal to 30 wt %, greater than or equal to 4 wt % and less than or equal to 28 wt %, or greater than or equal to 6 wt % and less than or equal to 26 wt %). Other ranges are also possible.

A non-woven fiber web may comprise fibrillated synthetic fibers comprising parent fibers of a variety of suitable diameters. In some embodiments, the non-woven fiber web comprises fibrillated synthetic fibers comprising parent fibers having an average diameter of greater than or equal to 3 microns, greater than or equal to 4 microns, greater than or equal to 5 microns, greater than or equal to 6 microns, greater than or equal to 7 microns, greater than or equal to 8 microns, greater than or equal to 9 microns, greater than or equal to 10 microns, greater than or equal to 11 microns, greater than or equal to 12 microns, greater than or equal to 13 microns, greater than or equal to 14 microns, greater than or equal to 15 microns, greater than or equal to 16 microns, greater than or equal to 17 microns, greater than or equal to 18 microns, or greater than or equal to 19 microns. In some embodiments, the non-woven fiber web may comprise fibrillated synthetic fibers comprising parent fibers having an average diameter of less than or equal to 20 microns, less than or equal to 19 microns, less than or equal to 18 microns, less than or equal to 17 microns, less than or equal to 16 microns, less than or equal to 15 microns, less than or equal to 14 microns, less than or equal to 13 microns, less than or equal to 12 microns, less than or equal to 11 microns, less than or equal to 10 microns, less than or equal to 9 microns, less than or equal to 8 microns, less than or equal to 7 microns, less than or equal to 6 microns, less than or equal to 5 microns, or less than or equal to 4 microns. Combinations of these ranges are also possible (e.g., greater than or equal to 3 microns and less than or equal to 20 microns, greater than or equal to 4 microns and less than or equal to 16 microns, greater than or equal to 6 microns and less than or equal to 14 microns, or greater than or equal to 8 microns and less than or equal to 12 microns). Other ranges are also possible.

In some embodiments, a fibrillated fiber median diameter of the fibrils is generally less than the average diameter of the parent fibers. Depending on the average diameter of the parent fibers, in some embodiments, the fibrils may have a median diameter of less than or equal to 10 microns, less than or equal to 7.5 microns, less than or equal to 5 microns, less than or equal to 2.5 microns, less than or equal to 1 micron, less than or equal to 0.5 microns, less than or equal to 0.1 microns, less than or equal to 0.05 microns, or less than or equal to 0.01 microns. In some embodiments the fibrils may have a median diameter of greater than or equal to 0.001 microns, greater than or equal to 0.01 micron, greater than or equal to 0.05 microns, greater than or equal to 0.1 microns, greater than or equal to 0.5 microns, greater than or equal to 1 micron, greater than or equal to 5 microns, or greater than or equal to 10 microns. Combinations of the above referenced ranges are also possible (e.g., fibrils having a median diameter of greater than or equal to about 0.001 micron and less than or equal to about 10 microns, greater than or equal to 0.1 micron and less than or equal to 7.5 microns, or greater than or equal to 0.5 micron and less than or equal to 5 microns). Other ranges are also possible.

A non-woven fiber web may comprise fibrillated synthetic fibers having any of a variety of suitable lengths. In some embodiments, the non-woven fiber web comprises synthetic fibers having an average length of greater than or equal to 1 mm, greater than or equal to 1.5 mm, greater than or equal to 2 mm, greater than or equal to 2.5 mm, greater than or equal to 3 mm, greater than or equal to 3.5 mm, greater than or equal to 4 mm, greater than or equal to 4.5 mm, greater than or equal to 5 mm, greater than or equal to 5.5 mm, greater than or equal to 6 mm, greater than or equal to 6.5 mm, greater than or equal to 7 mm, greater than or equal to 7.5 mm, greater than or equal to 8 mm, greater than or equal to 8.5 mm, greater than or equal to 9 mm, greater than or equal to 9.5 mm, greater than or equal to 10 mm, greater than or equal to 10.5 mm, greater than or equal to 11 mm, greater than or equal to 11.5 mm, greater than or equal to 12 mm, or greater than or equal to 12.5 mm. In some embodiments, the non-woven fiber web may comprise fibrillated synthetic fibers having an average length of less than or equal to 13 mm, less than or equal to 12.5 mm, less than or equal to 12 mm, less than or equal to 11.5 mm, less than or equal to 11 mm, less than or equal to 10.5 mm, less than or equal to 10 mm, less than or equal to 9.5 mm, less than or equal to 9 mm, less than or equal to 8.5 mm, less than or equal to 8 mm, less than or equal to 7.5 mm, less than or equal to 7 mm, less than or equal to 6.5 mm, less than or equal to 6 mm, less than or equal to 5.5 mm, less than or equal to 5 mm, less than or equal to 4.5 mm, less than or equal to 4 mm, less than or equal to 3.5 mm, less than or equal to 3 mm, less than or equal to 2.5 mm, less than or equal to 2 mm, or less than or equal to 1.5 mm. Combinations of these ranges are also possible (e.g., greater than or equal to 1 mm and less than or equal to 10 mm, greater than or equal to 2 mm and less than or equal to 10 mm, greater than or equal to 3 mm and less than or equal to 8 mm, or greater than or equal to 4 mm and less than or equal to 6 mm). Other ranges are also possible.

The average length of the fibrillated synthetic fibers refers to the average length of parent fibers from one end to an opposite end of the parent fibers. In some embodiments, the maximum average length of the fibrillated fibers falls within the above-noted ranges. The maximum average length refers to the average of the maximum dimension along one axis of the fibrillated fibers (including parent fibers and fibrils). It should be understood that, in certain embodiments, the fibers and fibrils may have dimensions outside the above-noted ranges.

The level of fibrillation of the fibrillated synthetic fibers may be measured according to any number of suitable methods. For example, the level of fibrillation can be measured according to a Canadian Standard Freeness (CSF) test, specified by TAPPI test method T 227 om 09 Freeness of pulp (2009). The test can provide an average CSF value. In some embodiments, the average CSF value of the fibrillated fibers may vary between 10 mL and about 750 mL. In certain embodiments, the average CSF value of the fibrillated fibers used in a non-woven fiber web may be greater than or equal to 10 mL, greater than or equal to 50 mL, greater than or equal to 100 mL, greater than or equal to 200 mL, greater than or equal to 400 mL, greater than or equal to 600 mL, or greater than or equal to 700 mL. In some embodiments, the average CSF value of the fibrillated fibers may be less than or equal to 800 mL, less than or equal to 600 mL, less than or equal to 400 mL, less than or equal to 200 mL, less than or equal to 100 mL, or less than or equal to 50 mL. Combinations of the above-referenced ranges are also possible (e.g., an average CSF value of fibrillated fibers of greater than or equal to about 10 mL and less than or equal to about 300 mL). Other ranges are also possible.

In some embodiments, a non-woven fiber web may contain fibrillated synthetic fibers having any of a variety of suitable compositions. In some embodiments, the fibrillated synthetic fibers may comprise a material described as being suitable for inclusion in the monocomponent fibers and/or bicomponent fibers discussed in detail below. For example, in some embodiments, the fibrillated synthetic fibers may comprise nitrogen-containing fibers (e.g., polyamide fibers and/or polyimide fibers). In some embodiments, the nitrogen-containing fibers may comprise aramid fibers. The aramid fibers may comprise polyparaphenylene terephthalamide. In some embodiments, the fibrillated synthetic fibers may comprise halogen-containing fibers (e.g., poly(vinyl chloride), poly(vinylidene chloride), poly(vinylidene fluoride), and/or poly(tetrafluoroethylene)).

In some embodiments, a non-woven fiber web may contain fibrillated synthetic fibers may have a relatively now flammability. In some embodiments, the fibrillated synthetic fibers may have a rating of V-0, 5VB, or 5VA under the UL 94 (2021) standard.

In some embodiments, a non-woven fiber web may contain synthetic fibers, such as fibrillated synthetic fibers, which have a high thermal stability. For example, in some embodiments, a non-woven fiber web comprises synthetic fibers that have a relatively high decomposition temperature. In some embodiments, such synthetic fibers may decompose in air at a temperature of greater than 400° C. The decomposition temperature of a synthetic fiber in air can be determined by performing thermogravimetric analysis (TGA) on a sample of that synthetic fiber in accordance with ASTM E2550 (2011). When performing this determination, the decomposition temperature may be defined as the onset temperature (To) and the onset temperature may be defined as the temperature at which the mass of the sample has decreased to be 98% of the baseline mass. Additionally, during this determination, the sample may be heated in air from room temperature to a temperature above the decomposition temperature at a rate of 5° C. per minute.

In some embodiments, a non-woven fiber web may contain synthetic fibers which are monocomponent fibers, such as monocomponent binder fibers, monocomponent chopped strand fibers, and/or monocomponent staple fibers. Monocomponent fibers may have any of a variety of suitable compositions. Non-limiting examples of suitable materials that may be included in monocomponent fibers include poly(vinyl alcohol); poly(olefin)s such as poly(ethylene), poly(propylene), and poly(butylene); poly(ester)s and co-poly(ester)s such as poly(ethylene terephthalate), co-poly(ethylene terephthalate), poly(butylene terephthalate), and poly(ethylene isophthalate); poly(amide) s and co-poly(amides) such as nylons and aramids (e.g., polyparaphenylene terephthalamide); poly(imide)s and co-poly(imide)s; halogenated polymers such as poly(vinyl chloride), poly(vinylidene chloride), poly(vinylidene fluoride), and/or poly(tetrafluoroethylene); epoxy; phenolic resins; and melamine. Suitable co-poly(ethylene terephthalate) s may comprise repeat units formed by the polymerization of ethylene terephthalate monomers and further comprise repeat units formed by the polymerization of one or more comonomers. Such comonomers may include linear, cyclic, and branched aliphatic dicarboxylic acids having 4-12 carbon atoms (e.g., butanedioic acid, pentanedioic acid, hexanedioic acid, dodecanedioic acid, and 1,4-cyclo-hexanedicarboxylic acid); aromatic dicarboxylic acids having 8-12 carbon atoms (e.g., isophthalic acid and 2,6-naphthalenedicarboxylic acid); linear, cyclic, and branched aliphatic diols having 3-8 carbon atoms (e.g., 1,3-propane diol, 1,2-propanediol, 1,4-butanediol, 3-methyl-1,5-pentanediol, 2,2-dimethyl-1,3-propanediol, 2-methyl-1,3-propanediol, and 1,4-cyclohexanediol); and/or aliphatic and aromatic/aliphatic ether glycols having 4-10 carbon atoms (e.g., hydroquinone bis(2-hydroxyethyl) ether and poly(ethylene ether) glycols having a molecular weight below 460 g/mol, such as diethylene ether glycol).

A non-woven fiber web may comprise monocomponent synthetic fibers in any of a variety of suitable amounts. In some embodiments, the non-woven fiber web comprises monocomponent synthetic fibers in an amount greater than or equal to 0.25 wt %, greater than or equal to 0.5 wt %, greater than or equal to 1 wt %, greater than or equal to 2 wt %, greater than or equal to 3 wt %, greater than or equal to 4 wt %, greater than or equal to 5 wt %, greater than or equal to 6 wt %, greater than or equal to 7 wt %, greater than or equal to 8 wt %, or greater than or equal to 9 wt % of the non-woven fiber web. In some embodiments, the non-woven fiber web comprises monocomponent synthetic fibers in an amount less than or equal to 10 wt %, less than or equal to 9 wt %, less than or equal to 8 wt %, less than or equal to 7 wt %, less than or equal to 6 wt %, less than or equal to 5 wt %, less than or equal to 4 wt %, less than or equal to 3 wt %, less than or equal to 2 wt %, less than or equal to 1 wt %, or less than or equal to 0.5 wt %, of the non-woven fiber web. Combinations of these ranges are also possible (e.g., greater than or equal to 0.25 wt % and less than or equal to 10 wt %, greater than or equal to 0.5 wt % and less than or equal to 9 wt %, or greater than 1 wt % and less than or equal to 8 wt %). Other ranges are also possible.

A non-woven fiber web may comprise monocomponent synthetic fibers having any of a variety of suitable diameters. In some embodiments, the non-woven fiber web comprises monocomponent synthetic fibers having an average diameter of greater than or equal to 3 microns, greater than or equal to 4 microns, greater than or equal to 5 microns, greater than or equal to 6 microns, greater than or equal to 7 microns, greater than or equal to 8 microns, greater than or equal to 9 microns, greater than or equal to 10 microns, greater than or equal to 11 microns, greater than or equal to 12 microns, greater than or equal to 13 microns, greater than or equal to 14 microns, greater than or equal to 15 microns, greater than or equal to 16 microns, greater than or equal to 17 microns, greater than or equal to 18 microns, or greater than or equal to 19 microns. In some embodiments, the non-woven fiber web may comprise monocomponent synthetic fibers having an average diameter of less than or equal to 20 microns, less than or equal to 19 microns, less than or equal to 18 microns, less than or equal to 17 microns, less than or equal to 16 microns, less than or equal to 15 microns, less than or equal to 14 microns, less than or equal to 13 microns, less than or equal to 12 microns, less than or equal to 11 microns, less than or equal to 10 microns, less than or equal to 9 microns, less than or equal to 8 microns, less than or equal to 7 microns, less than or equal to 6 microns, less than or equal to 5 microns, or less than or equal to 4 microns. Combinations of these ranges are also possible (e.g., greater than or equal to 3 microns and less than or equal to 20 microns, greater than or equal to 4 microns and less than or equal to 15 microns, or greater than or equal to 5 microns and less than or equal to 10 microns). Other ranges are also possible.

A non-woven fiber web may comprise monocomponent synthetic fibers having any of a variety of suitable lengths. In some embodiments, the non-woven fiber web comprises monocomponent synthetic fibers having an average length of greater than or equal to 1 mm, greater than or equal to 1.5 mm, greater than or equal to 2 mm, greater than or equal to 2.5 mm, greater than or equal to 3 mm, greater than or equal to 3.5 mm, greater than or equal to 4 mm, greater than or equal to 4.5 mm, greater than or equal to 5 mm, greater than or equal to 5.5 mm, greater than or equal to 6 mm, greater than or equal to 6.5 mm, greater than or equal to 7 mm, greater than or equal to 7.5 mm, greater than or equal to 8 mm, greater than or equal to 8.5 mm, greater than or equal to 9 mm, greater than or equal to 9.5 mm, greater than or equal to 10 mm, greater than or equal to 10.5 mm, greater than or equal to 11 mm, greater than or equal to 11.5 mm, greater than or equal to 12 mm, or greater than or equal to 12.5 mm. In some embodiments, the non-woven fiber web may comprise monocomponent synthetic fibers having an average length of less than or equal to 13 mm, less than or equal to 12.5 mm, less than or equal to 12 mm, less than or equal to 11.5 mm, less than or equal to 11 mm, less than or equal to 10.5 mm, less than or equal to 10 mm, less than or equal to 9.5 mm, less than or equal to 9 mm, less than or equal to 8 mm, less than or equal to 7.5 mm, less than or equal to 7 mm, less than or equal to 6.5 mm, less than or equal to 6 mm, less than or equal to 5.5 mm, less than or equal to 5 mm, less than or equal to 4.5 mm, less than or equal to 4 mm, less than or equal to 3.5 mm, less than or equal to 3 mm, less than or equal to 2.5 mm, less than or equal to 2 mm, or less than or equal to 1.5 mm. Combinations of these ranges are also possible (e.g., greater than or equal to 1 mm and less than or equal to 13 mm, greater than or equal to 1.5 mm and less than or equal to 8 mm, or greater than or equal to 2 mm and less than or equal to 4 mm). Other ranges are also possible.

In some embodiments, a non-woven fiber web may comprise synthetic fibers which are multicomponent fibers. The multicomponent fibers may comprise bicomponent fibers (i.e., fibers including two components), and/or may comprise fibers comprising three or more components. Multicomponent fibers may have any of a variety of suitable structures. For instance, a non-woven fiber web may comprise one or more of the following types of multicomponent fibers: core/sheath fibers (e.g., concentric core/sheath fibers, non-concentric core-sheath fibers), segmented pie fibers, side-by-side fibers, tip-trilobal fibers, and “island in the sca” fibers. Core-sheath bicomponent fibers may comprise a sheath that has a lower melting temperature than that of the core. When heated (e.g., during a binding step), the sheath may melt prior to the core, binding the non-woven fiber web together while the core remains solid. In such embodiments, the multicomponent fibers may serve as a binder for the non-woven fiber web.

Non-limiting examples of suitable materials that may be included in multicomponent fibers include poly(olefin)s such as poly(ethylene), poly(propylene), and poly(butylene); poly(ester)s and co-poly(ester) s such as poly(ethylene terephthalate) (e.g., amorphous poly(ethylene terephthalate)), co-poly(ethylene terephthalate), poly(butylene terephthalate), and poly(ethylene isophthalate); poly(amide)s and co-poly(amides) such as nylons and aramids; and halogenated polymers such as poly(tetrafluoroethylene). Suitable co-poly(ethylene terephthalate) s may comprise repeat units formed by the polymerization of ethylene terephthalate monomers and further comprise repeat units formed by the polymerization of one or more comonomers. Such comonomers may include linear, cyclic, and branched aliphatic dicarboxylic acids having 4-12 carbon atoms (e.g., butanedioic acid, pentanedioic acid, hexanedioic acid, dodecanedioic acid, and 1,4-cyclo-hexanedicarboxylic acid); aromatic dicarboxylic acids having 8-12 carbon atoms (e.g., isophthalic acid and 2,6-naphthalenedicarboxylic acid); linear, cyclic, and branched aliphatic diols having 3-8 carbon atoms (e.g., 1,3-propane diol, 1,2-propanediol, 1,4-butanediol, 3-methyl-1,5-pentanediol, 2,2-dimethyl-1,3-propanediol, 2-methyl-1,3-propanediol, and 1,4-cyclohexanediol); and/or aliphatic and aromatic/aliphatic ether glycols having 4-10 carbon atoms (e.g., hydroquinone bis(2-hydroxyethyl) ether and poly(ethylene ether) glycols having a molecular weight below 460 g/mol, such as diethylene ether glycol).

Non-limiting examples of suitable pairs of materials that may be included in bicomponent fibers include poly(ethylene)/poly(ethylene terephthalate), poly(propylene)/poly(ethylene terephthalate), co-poly(ethylene terephthalate)/poly(ethylene terephthalate), poly(butylene terephthalate)/poly(ethylene terephthalate), co-poly(amide)/poly(amide), and poly(ethylene)/poly(propylene). In the preceding list, the material having the lower melting temperature is listed first and the material having the higher melting temperature is listed second. Core-sheath bicomponent fibers comprising one of the above such pairs may have a sheath comprising the first material and a core comprising the second material.

In some embodiments, a non-woven fiber web may comprise multicomponent fibers in any of a variety of suitable amounts. In some embodiments, a non-woven fiber web may comprise multicomponent fibers in an amount greater than or equal to 1 wt %, greater than or equal to 1.5 wt %, greater than or equal to 2 wt %, greater than or equal to 2.5 wt %, greater than or equal to 3 wt %, greater than or equal to 3.5 wt %, greater than or equal to 4 wt %, greater than or equal to 4.5 wt %, greater than or equal to 5 wt %, greater than or equal to 5.5 wt %, greater than or equal to 6 wt %, greater than or equal to 6.5 wt %, greater than or equal to 7 wt %, greater than or equal to 7.5 wt %, greater than or equal to 8 wt %, greater than or equal to 8.5 wt %, greater than or equal to 9 wt %, or greater than or equal to 9.5 wt %. In some embodiments, a non-woven fiber web may comprise multicomponent fibers in an amount of less than or equal to 10 wt %, less than or equal to 9.5 wt %, less than or equal to 9 wt %, less than or equal to 8.5 wt %, less than or equal to 8 wt %, less than or equal to 7.5 wt %, less than or equal to 7 wt %, less than or equal to 6.5 wt %, less than or equal to 6 wt %, less than or equal to 5.5 wt %, less than or equal to 5 wt %, less than or equal to 4.5 wt %, less than or equal to 4 wt %, less than or equal to 3.5 wt %, less than or equal to 3 wt %, less than or equal to 2.5 wt %, less than or equal to 2 wt %, or less than or equal to 1.5 wt %. Combinations of these ranges are also possible (e.g., greater than or equal to 1 wt % and less than or equal to 10 wt %, greater than or equal to 1.5 wt % and less than or equal to 7 wt %, or greater than or equal to 2 wt % and less than or equal to 5 wt %). Other ranges are also possible.

A non-woven fiber web may comprise multicomponent fibers having any of a variety of suitable diameters. In some embodiments, a non-woven fiber web may comprise multicomponent fibers having an average diameter of greater than or equal to 4 microns, greater than or equal to 5 microns, greater than or equal to 6 microns, greater than or equal to 7 microns, greater than or equal to 8 microns, greater than or equal to 9 microns, greater than or equal to 10 microns, greater than or equal to 11 microns, greater than or equal to 12 microns, greater than or equal to 13 microns, greater than or equal to 14 microns, greater than or equal to 15 microns, greater than or equal to 16 microns, or greater than or equal to 17 microns. In some embodiments, a non-woven fiber web may comprise multicomponent fibers having an average diameter of less than or equal to 18 microns, less than or equal to 17 microns, less than or equal to 16 microns, less than or equal to 15 microns, less than or equal to 14 microns, less than or equal to 13 microns, less than or equal to 12 microns, less than or equal to 11 microns, less than or equal to 10 microns, less than or equal to 9 microns, less than or equal to 8 microns, less than or equal to 7 microns, less than or equal to 6 microns, or less than or equal to 5 microns. Combinations of these ranges are also possible (e.g., greater than or equal to 4 microns and less than or equal to 18 microns, greater than or equal to 6 microns and less than or equal to 16 microns, or greater than or equal to 8 microns and less than or equal to 14 microns). Other ranges are also possible.

A non-woven fiber web may comprise multicomponent fibers having any of a variety of suitable lengths. In some embodiments, a non-woven fiber web may comprise multicomponent fibers having an average length of greater than or equal to 1 mm, greater than or equal to 1.5 mm, greater than or equal to 2 mm, greater than or equal to 2.5 mm, greater than or equal to 3 mm, greater than or equal to 3.5 mm, greater than or equal to 4 mm, greater than or equal to 4.5 mm, greater than or equal to 5 mm, greater than or equal to 5.5 mm, greater than or equal to 6 mm, greater than or equal to 6.5 mm, greater than or equal to 7 mm, greater than or equal to 7.5 mm, greater than or equal to 8 mm, greater than or equal to 8.5 mm, greater than or equal to 9 mm, greater than or equal to 9.5 mm, greater than or equal to 10 mm, greater than or equal to 10.5 mm, greater than or equal to 11 mm, greater than or equal to 11.5 mm, greater than or equal to 12 mm, or greater than or equal to 13 mm. In some embodiments, a non-woven fiber web may comprise multicomponent fibers having an average length of less than or equal to 13 mm, less than or equal to 12.5 mm, less than or equal to 12 mm, less than or equal to 11.5 mm, less than or equal to 11 mm, less than or equal to 10.5 mm, less than or equal to 10 mm, less than or equal to 9.5 mm, less than or equal to 9 mm, less than or equal to 8.5 mm, less than or equal to 8 mm, less than or equal to 7.5 mm, less than or equal to 7 mm, less than or equal to 6.5 mm, less than or equal to 6 mm, less than or equal to 5.5 mm, less than or equal to 5 mm, less than or equal to 4.5 mm, less than or equal to 4 mm, less than or equal to 3.5 mm, less than or equal to 3 mm, or less than or equal to 2.5 mm. Combinations of these ranges are also possible (e.g., greater than or equal to 1 mm and less than or equal to 13 mm, greater than or equal to 3 mm and less than or equal to 10 mm, or greater than or equal to 4 mm and less than or equal to 8 mm). Other ranges are also possible.

The synthetic fibers, including monocomponent synthetic fibers and multicomponent fibers, described herein may comprise components having a variety of suitable melting points. In some embodiments, a binder fiber and/or a multicomponent fiber comprises a component having a melting point of greater than or equal to 70° C., greater than or equal to 80° C., greater than or equal to 90° C., greater than or equal to 100° C., greater than or equal to 110° C., greater than or equal to 120° C., greater than or equal to 130° C., greater than or equal to 140° C., greater than or equal to 150° C., greater than or equal to 160° C., greater than or equal to 170° C., greater than or equal to 180° C., greater than or equal to 190° C., greater than or equal to 200° C., greater than or equal to 210° C., greater than or equal to 220° C., greater than or equal to 250° C., greater than or equal to 300° C., greater than or equal to 350° C., or greater than or equal to 400° C. In some embodiments, a binder fiber and/or a multicomponent fiber comprises a component having a melting point less than or equal to 450° C., less than or equal to 400° C., less than or equal to 350° C., less than or equal to 300° C., less than or equal to 250° C., less than or equal to 220° C., less than or equal to 210° C., less than or equal to 200° C., less than or equal to 190° C., less than or equal to 180° C., less than or equal to 170° C., less than or equal to 160° C., less than or equal to 150° C., less than or equal to 140° C., less than or equal to 130° C., less than or equal to 120° C., less than or equal to 110° C., less than or equal to 100° C., less than or equal to 90° C., or less than or equal to 80° C. Combinations of the above-referenced ranges are also possible (e.g., greater than or equal to 70° C. and less than or equal to 450° C., greater than or equal to 80° C. and less than or equal to 450° C., greater than or equal to 80° C. and less than or equal to 230° C., or greater than or equal to 110° C. and less than or equal to 230° C.). Other ranges are also possible. In some embodiments, a binder fiber and/or a multicomponent fiber comprises a component having a melting point of less than or equal to 100° C.

The melting points of the components of monocomponent binder fibers and multicomponent fibers may be determined by performing differential scanning calorimetry. The differential scanning calorimetry measurement may be carried out by heating the fiber to 500° C. at 10° C./minute and determining the melting point of the component.

When a multicomponent fiber comprises two components, each component may independently have a melting point in one or more of the above-referenced ranges. Binder fibers and multicomponent fibers comprising two or more components may comprise exclusively components having the same melting point, exclusively components having different melting points, or at least one pair of components that have the same melting point and at least one pair of components that have different melting points.

Some non-woven fiber webs described herein comprise a combination of components and/or have an arrangement of components that result in the non-woven fiber web having a relatively low thermal conductivity. Such components may comprise particular fibers, such as those described above. Relevant arrangements of components may be those in which any components that are relatively thermally conductive are minimally connected and/or form relatively few networks that span the thickness of the non-woven fiber web. It is also possible for a non-woven fiber web to comprise a non-fibrous component having a relatively low thermal conductivity and/or that reduces the thermal conductivity of the non-woven fiber web as a whole. It is also possible for a non-woven fiber web to comprise a non-fibrous component which modifies the structure of the non-woven fiber web in a manner that results in the non-woven fiber web having a lower thermal conductivity. Incorporation of a non-fibrous component as an additive may reduce the thermal conductivity of a non-woven web, relative to a non-woven web with otherwise identical components and without the non-fibrous component.

One non-limiting example of such non-fibrous components is thermal conductivity-reducing particles. Some such particles have low thermal conductivities, and their incorporation into a non-woven fiber web may further reduce the thermal conductivity of the non-woven fiber web.

It is also possible for thermal conductivity-reducing particles to have other structural properties that reduce the thermal conductivity of the non-woven fiber web even if the particles are not inherently thermally insulating.

As one example, some thermal conductivity-reducing particles may have relatively high porosities. Without wishing to be bound by any particular theory, porous particles may reduce the thermal conductivity of the non-woven fiber web by reducing convective heat transfer through the non-woven fiber web.

As another example, some thermal conductivity-reducing particles may have relatively small average pore sizes. Without wishing to be bound by any particular theory, particles having small average pore sizes may reduce the thermal conductivity of the non-woven fiber web by reducing convective heat transfer through the non-woven fiber web.

Some thermal conductivity-reducing particles may have relatively high specific surface areas. In some cases, particles having high specific surface areas may indicate that these particles have relatively high porosities and/or relatively small average pore sizes.

As a third example, some thermal conductivity-reducing particles may have high refractive indices. Without wishing to be bound by any particular theory, particles with high refractive indices may reduce the thermal conductivity of the non-woven fiber web by reducing radiative heat transfer through the non-woven fiber web.

As another example, some thermal conductivity-reducing particles may be able to absorb radiative infrared (IR) heat. Without wishing to be bound by any particular theory, particles which are able to absorb radiative IR heat may reduce the thermal conductivity of the non-woven fiber web by reducing radiative heat transfer through the non-woven fiber web. In some embodiments, particles which are able to absorb radiative IR heat may be IR opacifiers.

As another example, some thermal conductivity-reducing particles may have relatively high aspect ratios. Without wishing to be bound by any particular theory, it is believed that particles with high aspect ratios may increase the mechanical stability of the non-woven fiber web and/or reduce convective heat transfer through the non-woven fiber web by increasing the tortuosity of the pores in the non-woven fiber web.

It should be understood that individual types of thermal conductivity-reducing particles present in the non-woven fiber webs described herein may have any combination of these properties. It should also be understood that a non-woven fiber web may comprise one or more type of thermal conductivity-reducing particle.

In some embodiments, a non-woven fiber web may comprise thermal conductivity-reducing particles in an amount of greater than or equal to 10 wt %, greater than or equal to 15 wt %, greater than or equal to 20 wt %, greater than or equal to 25 wt %, greater than or equal to 30 wt %, greater than 35 wt %, greater than or equal to 35 wt %, greater than or equal to 40 wt %, greater than or equal to 45 wt %, greater than or equal to 50 wt %, or greater than or equal to 55 wt % of the non-woven fiber web. In some embodiments, a non-woven fiber web may comprise thermal conductivity-reducing particles in an amount less than or equal to 60 wt %, less than or equal to 55 wt %, less than or equal to 50 wt %, less than or equal to 45 wt %, less than or equal to 40 wt %, less than or equal to 35 wt %, less than or equal to 30 wt %, less than or equal to 25 wt %, less than or equal to 20 wt %, or less than or equal to 15 wt % of the non-woven fiber web. Combinations of these ranges are also possible (e.g. a non-woven fiber web may comprise thermal conductivity-reducing particles in an amount greater than or equal to 10 wt % and less than or equal to 60 wt %, greater than or equal to 15 wt % and less than or equal to 55 wt %, or greater than or equal to 20 wt % and less than or equal to 50 wt %). Other ranges are also possible.

In some embodiments, a non-woven fiber web may comprise thermal conductivity-reducing particles that have a specific surface area of greater than or equal to 50 m²/g, greater than or equal to 100 m²/g, greater than or equal to 150 m²/g, greater than or equal to 200 m²/g, greater than or equal to 250 m²/g, greater than or equal to 300 m²/g, greater than or equal to 350 m²/g, greater than or equal to 400 m²/g, greater than or equal to 450 m²/g, greater than or equal to 500 m²/g, greater than or equal to 550 m²/g, greater than or equal to 600 m²/g, greater than or equal to 650 m²/g, greater than or equal to 700 m²/g, greater than or equal to 750 m²/g, or greater than or equal to 800 m²/g. In some embodiments, a non-woven fiber web may comprise thermal conductivity-reducing particles that have a specific surface area of less than or equal to 850 m²/g, less than or equal to 800 m²/g, less than or equal to 750 m²/g, less than or equal to 700 m²/g, less than or equal to 650 m²/g, less than or equal to 600 m²/g, less than or equal to 550 m²/g, less than or equal to 500 m²/g, less than or equal to 450 m²/g, less than or equal to 400 m²/g, less than or equal to 350 m²/g, less than or equal to 300 m²/g, less than or equal to 250 m²/g, less than or equal to 200 m²/g, less than or equal to 150 m²/g, or less than or equal to 100 m²/g. Combinations of these ranges are also possible (e.g. a non-woven fiber web may comprise thermal conductivity-reducing particles having a specific surface area of greater than or equal to 50 m²/g and less than or equal to 850 m²/g, greater than or equal to 100 m²/g and less than or equal to 800 m²/g, or greater than or equal to 150 m²/g and less than or equal to 750 m²/g). Other ranges are also possible. The specific surface area of the thermal conductivity-reducing particles can be determined by a multi-BET nitrogen absorption method in accordance with ASTM D1993 (2013).

In some embodiments, a non-woven fiber web may comprise thermal conductivity-reducing particles which have relatively small average pore sizes. For example, a non-woven fiber web may comprise thermal conductivity-reducing particles having an average pore size of less than or equal to 150 nm, less than or equal to 125 nm, less than or equal to 100 nm, less than or equal to 90 nm, less than or equal to 80 nm, less than or equal to 70 nm, less than or equal to 60 nm, less than or equal to 50 nm, less than or equal to 40 nm, less than or equal to 30 nm, or less than or equal to 20 nm. In some embodiments, a non-woven fiber web comprises thermal conductivity-reducing particles having an average pore size of greater than or equal greater than or equal to 10 nm, greater than or equal to 20 nm, greater than or equal to 30 nm, greater than or equal to 40 nm, greater than or equal to 50 nm, greater than or equal to 60 nm, greater than or equal to 70 nm, greater than or equal to 80 nm, greater than or equal to 90 nm, greater than or equal to 100 nm, or greater than or equal to 125 nm. Combinations of these ranges are also possible (e.g., a non-woven fiber web may comprise thermal conductivity-reducing particles having an average pore size of greater than or equal to 10 nm and less than or equal to 150 nm, greater than or equal to 20 nm and less than or equal to 125 nm, or greater than or equal to 30 nm and less than or equal to 100 nm). Other ranges are also possible.

The average pore size of a thermal conductivity-reducing particle may be determined in accordance with ASTM D4284-2012.

In some embodiments, a non-woven fiber web may comprise thermal conductivity-reducing particles of any of a variety of appropriate sizes. In some embodiments, the thermal conductivity-reducing particles may have an average diameter of greater than or equal to 1 micron, greater than or equal to 2.5 microns, greater than or equal to 3 microns, greater than or equal to 5 microns, greater than or equal to 7.5 microns, greater than or equal to 10 microns, greater than or equal to 12.5 microns, greater than or equal to 15 microns, greater than or equal to 17.5 microns, greater than or equal to 20 microns, greater than or equal to 22.5 microns, greater than or equal to 25 microns, greater than or equal to 27.5 microns, greater than or equal to 30 microns, greater than or equal to 40 microns, greater than or equal to 50 microns, greater than or equal to 60 microns, greater than or equal to 70 microns, greater than or equal to 80 microns, or greater than or equal to 90 microns. In some embodiments, a non-woven fiber web may comprise silica particles of an average diameter of less than or equal to 100 microns, less than or equal to 90 microns, less than or equal to 80 microns, less than or equal to 70 microns, less than or equal to 60 microns, less than or equal to 50 microns, less than or equal to 40 microns, less than or equal to 30 microns, less than or equal to 27.5 microns, less than or equal to 25 microns, less than or equal to 22.5 microns, less than or equal to 20 microns, less than or equal to 17.5 microns, less than or equal to 15 microns, less than or equal to 12.5 microns, less than or equal to 10 microns, less than or equal to 7.5 microns, less than or equal to 5 microns, less than or equal to 3 microns, or less than or equal to 2.5 microns. Combinations of these ranges are also possible (e.g., greater than or equal to 1 micron and less than or equal to 30 microns, greater than or equal to 3 microns and less than or equal to 20 microns, or greater than or equal to 5 microns and less than or equal to 15 microns). Other ranges are also possible.

In some embodiments, a non-woven fiber web may comprise thermal conductivity-reducing particles that have an average aspect ratio of greater than or equal to 20, greater than or equal to 50, greater than or equal to 100, greater than or equal to 200, greater than or equal to 500, greater than or equal to 1,000, greater than or equal to 2,000, greater than or equal to 3,000, greater than or equal to 4,000, greater than or equal to 5,000, greater than or equal to 6,000, greater than or equal to 7,000, greater than or equal to 8,000, or greater than or equal to 9,000. In some embodiments, a non-woven fiber web may comprise thermal conductivity-reducing particles having an average aspect ratio of less than or equal to 10,000, less than or equal to 9,000, less than or equal to 8,000, less than or equal to 7,000, less than or equal to 6,000, less than or equal to 5,000, less than or equal to 4,000, less than or equal to 3,000, less than or equal to 2,000, less than or equal to 1,000, less than or equal to 500, less than or equal to 200, less than or equal to 100, or less than or equal to 50. Combinations of these ranges are also possible (e.g. a non-woven fiber web may comprise thermal conductivity-reducing particles having an average aspect ratio of greater than or equal to 20 and less than or equal to 10,000, greater than or equal to 500 and less than or equal to 9,000, or greater than or equal to 1,000 and less than or equal to 8,000). Other ranges are also possible.

The aspect ratio of a particle may be determined by performing the following procedure: (1) Determining the three principal axes of the particle; (2) Determining the length of the particle along each of its principal axes; (3) Averaging the length of the longest and second-longest axes of the particle; and (4) Dividing the average length determined in (3) by the shortest length determined in (2) to obtain the aspect ratio of the particle. The average aspect ratio of the particles in a population of particles may be determined by performing the following procedure: (1) Determining the aspect ratio of each particle in the population of particles; and (2) Averaging these aspect ratios to obtain the average aspect ratio of the particles.

In some embodiments, a non-woven fiber web may comprise thermal conductivity-reducing particles that have a refractive index at 25° C. within a particular range at for a wavelength in a particular range.

In some embodiments, a non-woven fiber web comprises thermal conductivity-reducing particles that have a refractive index at 25° C. for a wavelength in a range provided below of greater than or equal to 1.5, greater than or equal to 2, greater than or equal to 2.5, greater than or equal to 3, greater than or equal to 3.5, greater than or equal to 4, greater than or equal to 4.5, greater than or equal to 5, greater than or equal to 5.5, greater than or equal to 6, or greater than or equal to 6.5. In some embodiments, a non-woven fiber web may comprise thermal conductivity-reducing particles that have a refractive index at 25° C. for a wavelength in a range provided below of less than or equal to 7, less than or equal to 6.5, less than or equal to 6, less than or equal to 5.5, less than or equal to 5, less than or equal to 4.5, less than or equal to 4, less than or equal to 3.5, less than or equal to 3, less than or equal to 2.5, or less than or equal to 2. Combinations of these ranges are also possible (e.g. greater than or equal to 1.5 and less than or equal to 7, greater than or equal to 2 and less than or equal to 7, greater than or equal to 2.5 and less than or equal to 6.5, or greater than or equal to 3 and less than or equal to 6). Other ranges are also possible.

In some embodiments, a non-woven fiber web comprises thermal conductivity-reducing particles that have a refractive index at 25° C. in a range provided above for a wavelength of greater than or equal to 400 nm, greater than or equal to 450 nm, greater than or equal to 500 nm, greater than or equal to 550 nm, greater than or equal to 600 nm, greater than or equal to 650 nm, greater than or equal to 700 nm, greater than or equal to 800 nm, greater than or equal to 900 nm, greater than or equal to 1 micron, greater than or equal to 2 microns, greater than or equal to 5 microns, greater than or equal to 7.5 microns, greater than or equal to 10 microns, greater than or equal to 20 microns, greater than or equal to 50 microns, greater than or equal to 75 microns, greater than or equal to 100 microns, greater than or equal to 200 microns, greater than or equal to 500 microns, or greater than or equal to 750 microns. In some embodiments, a non-woven fiber web comprises thermal conductivity-reducing particles that have a refractive index at 25° C. in a range provided above for a wavelength of less than or equal to 1 mm, less than or equal to 750 microns, less than or equal to 500 microns, less than or equal to 500 microns, less than or equal to 200 microns, less than or equal to 100 microns, less than or equal to 75 microns, less than or equal to 50 microns, less than or equal to 20 microns, less than or equal to 10 microns, less than or equal to 7.5 microns, less than or equal to 5 microns, less than or equal to 2 microns, less than or equal to 1 micron, less than or equal to 900 nm, less than or equal to 800 nm, less than or equal to 700 nm, less than or equal to 650 nm, less than or equal to 600 nm, less than or equal to 550 nm, less than or equal to 500 nm, or less than or equal to 450 nm. Combinations of these ranges are also possible (e.g. greater than or equal to 400 nm and less than or equal to 1 mm, greater than or equal to 400 nm and less than or equal to 700 nm, or greater than or equal to 700 nm and less than or equal to 1 mm). Other ranges are also possible.

In some embodiments, a non-woven fiber web may comprise thermal conductivity-reducing particles which are able to absorb radiative IR heat and/or particles which are IR opacifiers.

Any of a variety of appropriate thermal conductivity-reducing particles may be used in the non-woven fiber webs described herein. In some embodiments, such particles may comprise inorganic particles. In some embodiments, such particles may comprise particles having a relatively high specific surface area, such as silica (SiO₂) particles (e.g., fumed silica particles, precipitated silica particles). In some embodiments, such particles comprise particles having relatively high aspect ratios, such as vermiculite particles, bentonite particles, smectite particles, hectorite particles, kaolinite particles, montmorillonite particles, saponite particles, sepiolite particles, and/or sauconite particles. In some embodiments, such particles may comprise particles which can absorb radiative IR heat transfer (i.e., IR opacifiers), such as silicon carbide (SiC) particles, titania (TiO₂) particles, zirconia particles (ZrO₂), carbon black particles, boron nitride (BN) particles, iron oxide (Fe₃O₄), zirconium silicate (ZrSiO₄), and/or alumina (Al₂O₃) particles.

In some embodiments, a non-woven fiber web may comprise thermal conductivity-reducing particles that are silica particles. In some embodiments, non-woven fiber webs may comprise silica particles in an amount of greater than or equal to 20 wt %, greater than or equal to 22.5 wt %, greater than or equal to 25 wt %, greater than or equal to 27.5 wt %, greater than or equal to 30 wt %, greater than or equal to 32.5 wt %, greater than or equal to 35 wt %, greater than or equal to 37.5 wt %, greater than or equal to 40 wt %, greater than or equal to 42.5 wt %, greater than or equal to 45 wt %, greater than or equal to 47.5 wt %, or greater than or equal to 50 wt % of the non-woven fiber web. In some embodiments, a non-woven fiber web comprises silica particles in an amount of less than or equal to 55 wt %, less than or equal to 52.5 wt %, less than or equal to 50 wt %, less than or equal to 47.5 wt %, less than or equal to 45 wt %, less than or equal to 42.5 wt %, less than or equal to 40 wt %, less than or equal to 37.5 wt %, less than or equal to 35 wt %, less than or equal to 32.5 wt %, less than or equal to 30 wt %, less than or equal to 27.5 wt %, less than or equal to 25 wt %, or less than or equal to 22.5 wt % of the non-woven fiber web. Combinations of these ranges are also possible (e.g., greater than or equal to 20 wt % and less than or equal to 55 wt %, greater than or equal to 30 wt % and less than or equal to 50 wt %, or greater than or equal to 35 wt % and less than or equal to 45 wt %). Other ranges are also possible.

In some embodiments, a non-woven fiber web may comprise silica particles of any of a variety of appropriate sizes. In some embodiments, the silica particles may have an average diameter of greater than or equal to 1 micron, greater than or equal to 2.5 microns, greater than or equal to 3 microns, greater than or equal to 5 microns, greater than or equal to 7.5 microns, greater than or equal to 10 microns, greater than or equal to 12.5 microns, greater than or equal to 15 microns, greater than or equal to 17.5 microns, greater than or equal to 20 microns, greater than or equal to 22.5 microns, greater than or equal to 25 microns, greater than or equal to 27.5 microns, or greater than or equal to 29 microns. In some embodiments, a non-woven fiber web may comprise silica particles of an average diameter of less than or equal to 30 microns, less than or equal to 29 microns, less than or equal to 27.5 microns, less than or equal to 25 microns, less than or equal to 22.5 microns, less than or equal to 20 microns, less than or equal to 17.5 microns, less than or equal to 15 microns, less than or equal to 12.5 microns, less than or equal to 10 microns, less than or equal to 7.5 microns, less than or equal to 5 microns, less than or equal to 3 microns, or less than or equal to 2.5 microns. Combinations of these ranges are also possible (e.g., greater than or equal to 1 micron and less than or equal to 30 microns, greater than or equal to 3 microns and less than or equal to 20 microns, or greater than or equal to 5 microns and less than or equal to 15 microns). Other ranges are also possible.

In some embodiments, a non-woven fiber web may comprise silica particles that have a specific surface area of greater than or equal to 50 m²/g, greater than or equal to 100 m²/g, greater than or equal to 150 m²/g, greater than or equal to 200 m²/g, greater than or equal to 250 m²/g, greater than or equal to 300 m²/g, greater than or equal to 350 m²/g, greater than or equal to 400 m²/g, greater than or equal to 450 m²/g, greater than or equal to 500 m²/g, greater than or equal to 550 m²/g, greater than or equal to 600 m²/g, greater than or equal to 650 m²/g, greater than or equal to 700 m²/g, greater than or equal to 750 m²/g, or greater than or equal to 800 m²/g. In some embodiments, a non-woven fiber web may comprise silica particles that have a specific surface area of less than or equal to 850 m²/g, less than or equal to 800 m²/g, less than or equal to 750 m²/g, less than or equal to 700 m²/g, less than or equal to 650 m²/g, less than or equal to 600 m²/g, less than or equal to 550 m²/g, less than or equal to 500 m²/g, less than or equal to 450 m²/g, less than or equal to 400 m²/g, less than or equal to 350 m²/g, less than or equal to 300 m²/g, less than or equal to 250 m²/g, less than or equal to 200 m²/g, less than or equal to 150 m²/g, or less than or equal to 100 m²/g. Combinations of these ranges are also possible (e.g. a non-woven fiber web may comprise silica particles having a specific surface area of greater than or equal to 50 m²/g and less than or equal to 850 m²/g, greater than or equal to 100 m²/g and less than or equal to 800 m²/g, or greater than or equal to 150 m²/g and less than or equal to 750 m²/g). Other ranges are also possible. The specific surface area of the silica particles can be determined by a multi-BET nitrogen absorption method in accordance with ASTM D1993 (2013).

In some embodiments, the non-woven fiber web may lack silica particles.

In some non-limiting embodiments, a non-woven fiber web may comprise thermal conductivity-reducing particles that are mica particles. In some embodiments, a non-woven fiber web may comprise mica particles in an amount of greater than or equal to 30 wt %, greater than or equal to 32.5 wt %, greater than or equal to 35 wt %, greater than or equal to 37.5 wt %, greater than or equal to 40 wt %, greater than or equal to 42.5 wt %, greater than or equal to 45 wt %, greater than or equal to 47.5 wt %, greater than or equal to 50 wt %, greater than or equal to 52.5 wt %, greater than or equal to 55 wt %, or greater than or equal to 57.5 wt % of the non-woven fiber web. In some embodiments, a non-woven fiber web may comprise mica particles in an amount of less than or equal to 60 wt %, less than or equal to 57.5 wt %, less than or equal to 55 wt %, less than or equal to 52.5 wt %, less than or equal to 50 wt %, less than or equal to 47.5 wt %, less than or equal to 45 wt %, less than or equal to 42.5 wt %, less than or equal to 40 wt %, less than or equal to 37.5 wt %, less than or equal to 35 wt %, or less than or equal to 32.5 wt % of the non-woven fiber web. Combinations of these ranges are also possible (e.g., greater than or equal to 30 wt % or less than or equal to 60 wt %, greater than or equal to 35 wt % and less than or equal to 55 wt %, or greater than or equal to 40 wt % and less than or equal to 50 wt %). Other ranges are also possible.

In some embodiments, a non-woven fiber web may comprise mica particles of any of a variety of appropriate sizes. In some embodiments, the mica particles may have an average diameter of greater than or equal to 5 microns, greater than or equal to 10 microns, greater than or equal to 15 microns, greater than or equal to 25 microns, greater than or equal to 35 microns, greater than or equal to 45 microns, greater than or equal to 55 microns, greater than or equal to 65 microns, greater than or equal to 75 microns, greater than or equal to 85 microns, or greater than or equal to 95 microns. In some embodiments, the mica particles may have an average diameter of less than or equal to 100 microns, less than or equal to 95 microns, less than or equal to 85 microns, less than or equal to 75 microns, less than or equal to 65 microns, less than or equal to 55 microns, less than or equal to 45 microns, less than or equal to 35 microns, less than or equal to 25 microns, less than or equal to 15 microns, or less than or equal to 10 microns. Combinations of these ranges are also possible (e.g., greater than or equal to 5 microns and less than or equal to 100 microns, greater than or equal to 20 microns and less than or equal to 75 microns, or greater than or equal to 35 microns and less than or equal to 50 microns). Other ranges are also possible.

The diameter of a mica particle may be determined by the following procedure: (1) Determining the three principal axes of the particle; (2) Determining the length of the particle along each of its principal axes; and (3) Averaging the lengths of the longest two principal axes of the mica particle to obtain the diameter of the particle. The average diameter of the mica particles in a population of mica particles may be determined by performing the following procedure: (1) Determining the diameter of each particle in the population of particles; and (2) Averaging these diameters to obtain the diameter of the particles.

In some embodiments, a non-woven fiber web may comprise mica particles having an average aspect ratio of greater than or equal to 20, greater than or equal to 50, greater than or equal to 100, greater than or equal to 200, greater than or equal to 500, greater than or equal to 1,000, greater than or equal to 2,000, greater than or equal to 3,000, greater than or equal to 4,000, greater than or equal to 5,000, greater than or equal to 6,000, greater than or equal to 7,000, greater than or equal to 8,000, or greater than or equal to 9,000. In some embodiments, a non-woven fiber web may comprise mica particles having an average aspect ratio of less than or equal to 10,000, less than or equal to 9,000, less than or equal to 8,000, less than or equal to 7,000, less than or equal to 6,000, less than or equal to 5,000, less than or equal to 4,000, less than or equal to 3,000, less than or equal to 2,000, less than or equal to 1,000, less than or equal to 500, less than or equal to 200, less than or equal to 100, or less than or equal to 50. Combinations of these ranges are also possible (e.g. a non-woven fiber web may comprise thermal conductivity-reducing particles having an average aspect ratio of greater than or equal to 20 and less than or equal to 10,000, greater than or equal to 500 and less than or equal to 4,000, or greater than or equal to 1,000 and less than or equal to 10,000). Other ranges are also possible.

The aspect ratio of a mica particle may be determined as described above with respect to the determination of the average aspect ratio of thermal conductivity-reducing particles.

In some embodiments, a non-woven fiber web may comprise no mica particles.

In some non-limiting embodiments, a non-woven fiber web may comprise thermal conductivity-reducing particles which are silicon carbide particles. In some embodiments, the non-woven fiber web may comprise silicon carbide particles in an amount of greater than or equal to 5 wt %, greater than or equal to 7.5 wt %, greater than or equal to 10 wt, greater than or equal to 12.5 wt %, greater than or equal to 15 wt %, greater than or equal to 17.5 wt %, greater than or equal to 20 wt %, greater than or equal to 22.5 wt %, greater than or equal to 25 wt %, or greater than or equal to 27.5 wt % of the non-woven fiber web. In some embodiments, a non-woven fiber web may comprise silicon carbide particles in an amount of less than or equal to 30 wt %, less than or equal to 27.5 wt %, less than or equal to 25 wt %, less than or equal to 22.5 wt %, less than or equal to 20 wt %, less than or equal to 17.5 wt %, less than or equal to 15 wt %, less than or equal to 12.5 wt %, less than or equal to 10 wt %, or less than or equal to 7.5 wt % of the non-woven fiber web. Combinations of these ranges are also possible (e.g., greater than or equal to 5 wt % and less than or equal to 30 wt %, greater than or equal to 10 wt % and less than or equal to 25 wt %, or greater than or equal to 15 wt % and less than or equal to 20 wt %). Other ranges are also possible.

In some embodiments, a non-woven fiber web may comprise silicon carbide particles of any of a variety of appropriate sizes. In some embodiments, the non-woven fiber web may comprise silicon carbide particles having an average diameter of greater than or equal to 1 micron, greater than or equal to 2.5 microns, greater than or equal to 5 microns, greater than or equal to 7.5 microns, greater than or equal to 10 microns, greater than or equal to 12.5 microns, greater than or equal to 15 microns, greater than or equal to 17.5 microns, greater than or equal to 20 microns, greater than or equal to 22.5 microns, greater than or equal to 25 microns, or greater than or equal to 27.5 microns. In some embodiments, a non-woven fiber web may comprise silicon carbide particles having an average diameter of less than or equal to 30 microns, less than or equal to 27.5 microns, less than or equal to 25 microns, less than or equal to 22.5 microns, less than or equal to 20 microns, less than or equal to 17.5 microns, less than or equal to 15 microns, less than or equal to 12.5 microns, less than or equal to 10 microns, less than or equal to 7.5 microns, less than or equal to 5 microns, or less than or equal to 2.5 microns. Combinations of these ranges are also possible (e.g., greater than or equal to 1 micron and greater than or equal to 30 microns, greater than or equal to 3 microns and less than or equal to 20 microns, or greater than or equal to 5 microns and less than or equal to 10 microns). Other ranges are also possible.

In some embodiments, a non-woven fiber web may comprise no silicon carbide particles.

In some embodiments, a non-woven fiber web described herein comprises an aerogel. Some aerogels have low thermal conductivities, and their incorporation into a non-woven fiber web may further reduce the thermal conductivity of the non-woven fiber web. An aerogel may be a low-density, porous material. In some embodiments, an aerogel takes the form of a porous solid (e.g., a microporous solid) in which a gas (e.g., air) is disposed in the pores. In some embodiments, aerogels are produced by extraction of a liquid from a gel to produce a solid matrix. This may be accomplished by supercritical drying and/or freeze-drying. During or after liquid extraction, gas may be infiltrated into some or all of the locations at which the liquid was originally present.

In some embodiments, non-woven fiber webs may comprise an aerogel in an amount of greater than or equal to 20 wt %, greater than or equal to 22.5 wt %, greater than or equal to 25 wt %, greater than or equal to 27.5 wt %, greater than or equal to 30 wt %, greater than or equal to 32.5 wt %, greater than or equal to 35 wt %, greater than or equal to 37.5 wt %, greater than or equal to 40 wt %, greater than or equal to 42.5 wt %, greater than or equal to 45 wt %, greater than or equal to 47.5 wt %, or greater than or equal to 50 wt % of the non-woven fiber web. In some embodiments, a non-woven fiber web comprises an aerogel in an amount of less than or equal to 55 wt %, less than or equal to 52.5 wt %, less than or equal to 50 wt %, less than or equal to 47.5 wt %, less than or equal to 45 wt %, less than or equal to 42.5 wt %, less than or equal to 40 wt %, less than or equal to 37.5 wt %, less than or equal to 35 wt %, less than or equal to 32.5 wt %, less than or equal to 30 wt %, less than or equal to 27.5 wt %, less than or equal to 25 wt %, or less than or equal to 22.5 wt % of the non-woven fiber web. Combinations of these ranges are also possible (e.g., greater than or equal to 20 wt % and less than or equal to 55 wt %, greater than or equal to 30 wt % and less than or equal to 50 wt %, or greater than or equal to 35 wt % and less than or equal to 45 wt %). Other ranges are also possible.

Aerogels present in the non-woven fiber webs described herein may have a variety of suitable morphologies. In some embodiments, a non-woven fiber web comprises thermal conductivity-reducing particles that are aerogel particles. As described in further detail below, it is also possible for one or more aerogel precursors are impregnated into a non-woven fiber web and reacted to form an aerogel matrix in which the fibers of the non-woven fiber web are embedded.

Any of a variety of appropriate aerogels may be used. As one example, some aerogels comprise a cross-linked, macromolecular structure. As another example, some aerogels are ceramic. For instance, some aerogels comprise an inorganic oxide. Non-limiting examples of inorganic oxide aerogels are silica aerogels, silica hybrid aerogels (e.g., a silica hybrid aerogel having the formula (SiO₂)ₓ(RSiO_{1.5})_{y}, where R may be an alkyl group, such as a methyl group, an ethyl group, a propyl group, or a butyl group), titania aerogels, and alumina aerogels. Without wishing to be bound by any particular theory, it is believed that aerogels having the formula (SiO₂)ₓ(RSiO_{1.5})_{y} may advantageously be relatively hydrophobic and/or resist moisture uptake from air. In some embodiments, an aerogel comprises two or more of the above-described types of aerogels. It should, of course, be understood that these examples are non-limiting and that other aerogels may be used.

An aerogel used in a non-woven fiber web described herein may have a relatively high stability at high temperatures. For example, a non-woven fiber web described herein may comprise an aerogel having any of a variety of suitable melting temperatures. In some embodiments, a non-woven fiber web comprises an aerogel having a melting temperature of greater than or equal to greater than or equal to 600° C., greater than or equal to 700° C., greater than or equal to 800° C., greater than or equal to 900° C., greater than or equal to 1,000° C., greater than or equal to 1,050° C., greater than or equal to 1,100° C., greater than or equal to 1,200° C., greater than or equal to 1,300° C., greater than or equal to 1,400° C., greater than or equal to 1,500° C., greater than or equal to 1,600° C., greater than or equal to 1,700° C., greater than or equal to 1,800° C., greater than or equal to 1,900° C., greater than or equal to 2,000° C., or greater than or equal to 2,100° C. In some embodiments, a non-woven fiber web comprises an aerogel having a melting temperature of less than or equal to 2,200° C., less than or equal to 2,100° C., less than or equal to 2,000° C., less than or equal to 1,900° C., less than or equal to 1,800° C., less than or equal to 1,700° C., less than or equal to 1,600° C., less than or equal to 1,500° C., less than or equal to 1,400° C., less than or equal to 1,300° C., less than or equal to 1,200° C., less than or equal to 1,100° C., less than or equal to 1,000° C., less than or equal to 900° C., less than or equal to 800° C., or less than or equal to 700° C. Combinations of these ranges are also possible (e.g., greater than or equal to 600° C. and less than or equal to 2,200° C., greater than or equal to 700° C. and less than or equal to 2,100° C., or greater than or equal to 800° C. and less than or equal to 2,000° C.). Other ranges are also possible. The melting point of an aerogel may be determined in accordance with ASTM E794-2006.

An aerogel described herein may have a relatively high porosity. In some embodiments, a non-woven fiber web comprises an aerogel having a porosity of greater than or equal to 90%, greater than or equal to 92%, greater than or equal to 95%, greater than or equal to 97%, greater than or equal to 97.5%, greater than or equal to 98%, greater than or equal to 98.5%, greater than or equal to 99%, or greater than or equal to 99.5%. In some embodiments, a non-woven fiber web comprises an aerogel having a porosity of less than 100%, less than or equal to 99.9%, less than or equal to 99.5%, less than or equal to 99%, less than or equal to 98.5%, less than or equal to 98%, less than or equal to 97.5%, less than or equal to 97%, less than or equal to 95%, or less than or equal to 92%. Combinations of these ranges are also possible (e.g., greater than or equal to 90% and less than 100%, or greater than or equal to 97% and less than 100%). Other ranges are also possible. The porosity of an aerogel may be determined in accordance with ASTM D4284-2012.

Some aerogels have a relatively fine average pore diameter. In some embodiments, a non-woven fiber web comprises an aerogel having an average pore diameter of less than or equal to 150 nm, less than or equal to 125 nm, less than or equal to 100 nm, less than or equal to 90 nm, less than or equal to 80 nm, less than or equal to 70 nm, less than or equal to 60 nm, less than or equal to 50 nm, less than or equal to 40 nm, or less than or equal to 30 nm. In some embodiments, a non-woven fiber web comprises an aerogel having an average pore diameter of greater than or equal to 0.5 nm, greater than or equal to 1 nm, greater than or equal to 2 nm, greater than or equal to 3 nm, greater than or equal to 4 nm, greater than or equal to 5 nm, greater than or equal to 8 nm, greater than or equal to 10 nm, greater than or equal to 15 nm, greater than or equal to 20 nm, greater than or equal to 30 nm, greater than or equal to 40 nm, greater than or equal to 50 nm, greater than or equal to 60 nm, greater than or equal to 70 nm, or greater than or equal to 80 nm. Combinations of these ranges are also possible (e.g., greater than or equal to 0.5 nm and less than or equal to 150 nm). Other ranges are also possible. The average pore diameter of an aerogel may be determined in accordance with ASTM D4284-2012.

In some embodiments, an aerogel may have a relatively low liquid water uptake. Such aerogels may advantageously retain a relatively low amount of water after being exposed to liquid water. In some embodiments, an aerogel has a liquid water uptake of less than or equal to 100 wt %, less than or equal to 90 wt %, less than or equal to 75 wt %, less than or equal to 50 wt %, less than or equal to 25 wt %, less than or equal to 10 wt %, less than or equal to 5 wt %, less than or equal to 1 wt %, less than or equal to 0.5 wt %, or less than or equal to 0.1 wt %. In some embodiments, an aerogel has a liquid water uptake of greater than or equal to 0 wt %, greater than or equal to 0.1 wt %, greater than or equal to 0.5 wt %, greater than or equal to 1 wt %, greater than or equal to 5 wt %, greater than or equal to 10 wt %, or greater than or equal to 25 wt %. Combinations of these ranges are also possible (e.g., greater than or equal to 0 wt % and less than or equal to 100 wt %). Other ranges are also possible. In some embodiments, the liquid water uptake of an aerogel is 0 wt %. The liquid water uptake of an aerogel exposed to liquid water may be determined by ASTM C1511-15.

In some embodiments, an aerogel may be configured to have a relatively low water vapor uptake. Such aerogels may advantageously retain a relatively low amount of water after being exposed to water vapor. In some embodiments, an aerogel has a water vapor uptake of less than or equal to 50 wt %, less than or equal to 40 wt %, less than or equal to 30 wt %, less than or equal to 25 wt %, less than or equal to 20 wt %, less than or equal to 15 wt %, less than or equal to 10 wt %, less than or equal to 5 wt %, less than or equal to 1 wt %, less than or equal to 0.5 wt %, or less than or equal to 0.1 wt %. In some embodiments, an aerogel has a water vapor uptake of greater than or equal to 0 wt %, greater than or equal to 0.1 wt %, greater than or equal to 0.5 wt %, greater than or equal to 1 wt %, greater than or equal to 5 wt %, greater than or equal to 10 wt %, or greater than or equal to 25 wt %. Combinations of these ranges are also possible (e.g., greater than or equal to 0 wt % and less than or equal to 50 wt %). Other ranges are also possible. In some embodiments, the water vapor uptake of an aerogel is 0 wt %. The water vapor uptake of an aerogel may be determined by ASTM C1104-13A.

In some embodiments, a non-woven fiber web comprises an aerogel that is hydrophobic or an aerogel that is hydrophilic. For example, in some embodiments a non-woven fiber web comprises a hydrophilic aerogel such as a silica aerogel, an alumina aerogel, and/or a titanium aerogel. In some embodiments, a non-woven fiber web comprises a hydrophobic aerogel such as an aerogel modified to include an organic group having the structure (e.g. (SiO₂)ₓ(RSiO_{1.5}) aerogel).

An aerogel may have any of a variety of suitable water contact angles. In some embodiments, a hydrophilic aerogel has a water contact angle greater than or equal to 0°, greater than or equal to 10°, greater than or equal to 20°, greater than or equal to 30°, greater than or equal to 40°, greater than or equal to 50°, greater than or equal to 60°, greater than or equal to 70°, or greater than or equal to 80°. In some embodiments, a hydrophilic aerogel may have a water contact angle less than or equal to 90°, less than or equal to 80°, less than or equal to 70°, less than or equal to 60°, less than or equal to 50°, less than or equal to 40°, less than or equal to 30°, less than or equal to 20°, or less than or equal to 10°. Combinations of these ranges are also possible (e.g. a hydrophilic aerogel may have a water contact angle greater than or equal to 0° and less than or equal to 90°, greater than or equal to 10° and less than or equal to 80°, or greater than or equal to 20° and less than or equal to) 70°. Other ranges are also possible.

The water contact angle may be measured using standard ASTM D5946 (2009). The water contact angle is the angle between the surface of the aerogel and the tangent line drawn to the water droplet surface at the three-phase point (solid, liquid, and gas phase point) when a liquid drop is resting on the substrate surface. A contact angle meter or goniometer can be used for this determination.

In some embodiments, a hydrophobic aerogel has a water contact angle of greater than or equal to 90°, greater than or equal to 100°, greater than or equal to 110°, greater than or equal to 120°, greater than or equal to 130°, greater than or equal to 140°, greater than or equal to 150°, greater than or equal to 160°, or greater than or equal to 170°. In some embodiments, a hydrophobic aerogel has a water contact angle of less than or equal to 180°, less than or equal to 170°, less than or equal to 160°, less than or equal to 150°, less than or equal to 140°, less than or equal to 130°, less than or equal to 120°, less than or equal to 110°, or less than or equal to 100°. Combinations of these ranges are also possible (e.g. a hydrophobic aerogel may have a water contact angle of greater than or equal to 90° and less than or equal to 180°, greater than or equal to 100° and less than or equal to 170°, or greater than or equal to 110° and less than or equal to) 160°. Other ranges are also possible.

In some embodiments, a non-woven fiber web further comprises a resin (e.g., a non-fibrous resin). Resins suitable for inclusion in the non-woven fiber web may have any of a variety of suitable compositions. In some embodiments, the resin may comprise a polymer, such as poly(vinyl chloride), poly(vinyl alcohol), poly(vinylidene chloride), poly(vinylidene fluoride), polyacrylic acid, polyurethane, and/or Teflon.

In some embodiments, a resin may comprise one or more flame retardants. In some embodiments, a resin comprises an antimony-containing flame retardant such as antimony trioxide, antimony pentoxide, and/or sodium antimonate. In some embodiments, a resin comprises organohalogen flame retardant, such as chlorendic acid derivatives and/or chlorinated paraffins. In some embodiments, a resin comprises an organobromine flame retardant, such as decabromodiphenyl ether, decabromodiphenyl ethane, a polymeric brominated compound (e.g., brominated polystyrene), a brominated carbonate oligomer (BCO), a brominated epoxy oligomer (BEO), tetrabromophthalic anyhydride, tetrabromobisphenol A, and/or hexabromocyclododecane. In some embodiments, a resin comprises an organophosphate flame retardant such as triphenyl phosphate, resorcinol bis(diphenylphosphate), bisphenol A diphenyl phosphate, and/or tricresyl phosphate. In some embodiments, a resin comprises a phosphonate flame retardant, such as dimethyl methylphosphonate. In some embodiments, a resin comprises a phosphinate flame retardant, such as aluminum diethyl phosphinate.

In some embodiments, a non-woven fiber web may comprise a resin which has advantageous properties such as a low flammability, low thermal conductivity, or other properties which may reduce the thermal conductivity and/or increase the thermal stability of the non-woven fiber web.

In some embodiments, a fiber web may comprise a resin in an amount of greater than or equal to 2 wt %, greater than or equal to 3 wt %, greater than or equal to 4 wt %, greater than or equal to 5 wt %, greater than or equal to 6 wt %, greater than or equal to 7 wt %, greater than or equal to 8 wt %, greater than or equal to 9 wt %, greater than or equal to 10 wt %, or greater than or equal to 11 wt % of the non-woven fiber web. In some embodiments, a fiber web may comprise a resin in an amount of less than or equal to 12 wt %, less than or equal to 11 wt %, less than or equal to 10 wt %, less than or equal to 9 wt %, less than or equal to 8 wt %, less than or equal to 7 wt %, less than or equal to 6 wt %, less than or equal to 5 wt %, less than or equal to 4 wt %, or less than or equal to 3 wt % of the non-woven fiber web. Combinations of these ranges are also possible (e.g., greater than or equal to 2 wt % and less than or equal to 12 wt %, greater than or equal to 3 wt % and less than or equal to 10 wt %, or greater than or equal to 4 wt % and less than or equal to 8 wt %). Other ranges are also possible.

A non-woven fiber web may have any of a variety of suitable porosities. In some embodiments, a non-woven fiber web has a porosity of greater than or equal to 75%, greater than or equal to 77.5%, greater than or equal to 80%, greater than or equal to 82.5%, greater than or equal to 85%, greater than or equal to 87.5%, greater than or equal to 90%, or greater than or equal to 92.5%. In some embodiments, a non-woven fiber web has a porosity of less than or equal to 95%, less than or equal to 92.5%, less than or equal to 90%, less than or equal to 87.5%, less than or equal to 85%, less than or equal to 82.5%, less than or equal to 80%, or less than or equal to 77.5%. Combinations of these ranges are also possible (e.g., greater than or equal to 75% and less than or equal to 95%, greater than or equal to 80% and less than or equal to 92.5%, or greater than or equal to 85% and less than or equal to 90%). Other ranges are also possible.

The porosity of a non-woven fiber web is equivalent to 100%-[solidity of the non-woven fiber web]. The solidity of a non-woven fiber web is equivalent to the percentage of the interior of the non-woven fiber web occupied by solid material. One non-limiting way of determining solidity of a non-woven fiber web is described in this paragraph, but other methods are also possible. The method described in this paragraph includes determining the basis weight and thickness of the non-woven fiber web and then applying the following formula: solidity=[basis weight of the non-woven fiber web/(density of the components forming the non-woven fiber web·thickness of the non-woven fiber web)]·100%. The density of the components forming the non-woven fiber web is equivalent to the average density of the material or material(s) forming the components of the non-woven fiber web (e.g., fibers, particles, aerogels), which is typically specified by the manufacturer of each material. The average density of the materials forming the components of the non-woven fiber web may be determined by: (1) determining the total volume of all of the components in the non-woven fiber web; and (2) dividing the total mass of all of the components in the non-woven fiber web by the total volume of all of the components in the non-woven fiber web. If the mass and density of each component of the non-woven fiber web are known, the volume of all the components in the non-woven fiber web may be determined by: (1) for each type of component, dividing the total mass of the component in the non-woven fiber web by the density of the component; and (2) summing the volumes of each component. If the mass and density of each component of the non-woven fiber web are not known, the volume of all the components in the non-woven fiber web may be determined in accordance with Archimedes' principle.

A non-woven fiber web may have any of a variety of suitable mean flow pore sizes. In some embodiments, a non-woven fiber web may have a mean flow pore size of greater than or equal to 0.25 micron, greater than or equal to 0.5 micron, greater than or equal to 1 micron, greater than or equal to 1.5 microns, greater than or equal to 2 microns, greater than or equal to 2.5 microns, greater than or equal to 3 microns, greater than or equal to 3.5 microns, greater than or equal to 4 microns, greater than or equal to 4.5 microns, greater than or equal to 5 microns, greater than or equal to 5.5 microns, greater than or equal to 6 microns, or greater than or equal to 7 microns. In some embodiments, a non-woven fiber web may have a mean flow pore size of less than or equal to 7.5 microns, less than or equal to 7 microns, less than or equal to 6.5 microns, less than or equal to 6 microns, less than or equal to 5.5 microns, less than or equal to 5 microns, less than or equal to 4.5 microns, less than or equal to 4 microns, less than or equal to 3.5 microns, less than or equal to 3 microns, less than or equal to 2.5 microns, less than or equal to 2 microns, less than or equal to 1.5 microns, less than or equal to 1 micron, or less than or equal to 0.5 micron. Combinations of these ranges are also possible (e.g. a non-woven fiber web may have a mean flow pore size of greater than or equal to 0.25 micron and less than or equal to 7.5 microns, greater than or equal to 0.5 micron and less than or equal to 7 microns, or greater than or equal to 1 micron and less than or equal to 6 microns). Combinations of these ranges are also possible. The mean flow pore size may be determined according to the standard ASTM D4284-2012.

A non-woven fiber web may have any of a variety of suitable maximum pore sizes. In some embodiments, a non-woven fiber web may have a maximum pore size of greater than or equal to 5 microns, greater than or equal to 7.5 microns, greater than or equal to 10 microns, greater than or equal to 12.5 microns, greater than or equal to 15 microns, greater than or equal to 17.5 microns, greater than or equal to 20 microns, greater than or equal to 22.5 microns, greater than or equal to 25 microns, or greater than or equal to 27.5 microns. In some embodiments, a non-woven fiber web may have a maximum pore size of less than or equal to 30 microns, less than or equal to 27.5 microns, less than or equal to 25 microns, less than or equal to 22.5 microns, less than or equal to 20 microns, less than or equal to 17.5 microns, less than or equal to 15 microns, less than or equal to 12.5 microns, less than or equal to 10 microns, or less than or equal to 7.5 microns. The maximum pore size may be determined according to the standard ASTM D6767-2021.

A non-woven fiber web may have any of a variety of suitable densities. In some embodiments, a non-woven fiber web may have a density of greater than or equal to 0.15 g/cm³, greater than or equal to 0.175 g/cm³, greater than or equal to 0.2 g/cm³, greater than or equal to 0.225 g/cm³, greater than or equal to 0.25 g/cm³, greater than or equal to 0.275 g/cm³, greater than or equal to 0.3 g/cm³, greater than or equal to 0.325 g/cm³, greater than or equal to 0.35 g/cm³, greater than or equal to 0.375 g/cm³, greater than or equal to 0.4 g/cm³, or greater than or equal to 0.425 g/cm³. In some embodiments, a non-woven fiber web may have a density of less than or equal to 0.45 g/cm³, less than or equal to 0.425 g/cm³, less than or equal to 0.4 g/cm³, less than or equal to 0.375 g/cm³, less than or equal to 0.35 g/cm³, less than or equal to 0.325 g/cm³, less than or equal to 0.3 g/cm³, less than or equal to 0.275 g/cm³, less than or equal to 0.25 g/cm³, less than or equal to 0.225 g/cm³, less than or equal to 0.2 g/cm³, or less than or equal to 0.175 g/cm³. Combinations of these ranges are also possible (e.g. a non-woven fiber web may have a density of greater than or equal to 0.15 g/cm³ and less than or equal to 0.45 g/cm³, greater than or equal to 0.2 g/cm³ and less than or equal to 0.4 g/cm³, or greater than or equal to 0.25 g/cm³ and less than or equal to 0.35 g/cm³). Other ranges are also possible. The density can be determined using the following formula: basis weight of the non-woven fiber web/[(thickness of the non-woven fiber web in mm)·(1000)].

A non-woven fiber web may have any of a variety of suitable basis weights. In some embodiments, a non-woven fiber web may have a basis weight of greater than or equal to 100 g/m², greater than or equal to 150 g/m², greater than or equal to 200 g/m², greater than or equal to 250 g/m², greater than or equal to 300 g/m², greater than or equal to 350 g/m², greater than or equal to 400 g/m², greater than or equal to 450 g/m², greater than or equal to 500 g/m², greater than or equal to 550 g/m², greater than or equal to 600 g/m², greater than or equal to 650 g/m², greater than or equal to 700 g/m², or greater than or equal to 750 g/m². In some embodiments, a non-woven fiber web may have a basis weight of less than or equal to 800 g/m², less than or equal to 750 g/m², less than or equal to 700 g/m², less than or equal to 650 g/m², less than or equal to 600 g/m², less than or equal to 550 g/m², less than or equal to 500 g/m², less than or equal to 450 g/m², less than or equal to 400 g/m², less than or equal to 350 g/m², less than or equal to 300 g/m², or less than or equal to 250 g/m². Combinations of these ranges are also possible (e.g., greater than or equal to 100 g/m² and less than or equal to 800 g/m², greater than or equal to 150 g/m² and less than or equal to 700 g/m², or greater than or equal to 200 g/m² and less than or equal to 600 g/m²). Other ranges are also possible. The basis weight of a non-woven fiber web may be determined according to the standard ISO 536:2012.

A non-woven fiber web may have any of a variety of suitable thicknesses. In some embodiments, a non-woven fiber web has a thickness of greater than or equal to 0.1 mm, greater than or equal to 0.3 mm, greater than or equal to 0.5 mm, greater than or equal to 0.7 mm, greater than or equal to 0.9 mm, greater than or equal to 1 mm, greater than or equal to 1.1 mm, greater than or equal to 1.3 mm, greater than or equal to 1.5 mm, greater than or equal to 1.7 mm, greater than or equal to 1.9 mm, greater than or equal to 2.1 mm, greater than or equal to 2.3 mm, greater than or equal to 2.5 mm, greater than or equal to 2.7 mm, or greater than or equal to 2.9 mm. In some embodiments, a non-woven fiber web has a thickness of less than or equal to 3 mm, less than or equal to 2.9 mm, less than or equal to 2.7 mm, less than or equal to 2.5 mm, less than or equal to 2.3 mm, less than or equal to 2.1 mm, less than or equal to 1.9 mm, less than or equal to 1.7 mm, less than or equal to 1.5 mm, less than or equal to 1.3 mm, less than or equal to 1.1 mm, less than or equal to 0.9 mm, less than or equal to 0.7 mm, less than or equal to 0.5 mm, or less than or equal to 0.3 mm. Combinations of these ranges are also possible (e.g., greater than or equal to 0.1 mm and less than or equal to 3 mm, greater than or equal to 0.3 mm and less than or equal to 2.5 mm, or greater than or equal to 0.5 mm and less than or equal to 2 mm). Other ranges are also possible. The thickness of a non-woven fiber web may be determined according to the standard BCIS-03A, Sept-09, Method 10 under 10 kPa applied pressure.

A non-woven fiber web may have any of a variety of suitable values of air permeability. In some embodiments, a non-woven fiber web has an air permeability of greater than or equal to 0.25 cubic feet per minute per square foot (CFM), greater than or equal to 0.5 CFM, greater than or equal to 0.75 CFM, greater than or equal to 1 CFM, greater than or equal to 1.25 CFM, greater than or equal to 1.5 CFM, greater than or equal to 1.75 CFM, greater than or equal to 2 CFM, greater than or equal to 2.25 CFM, greater than or equal to 2.5 CFM, greater than or equal to 2.75 CFM, greater than or equal to 3 CFM, greater than or equal to 3.25 CFM, greater than or equal to 3.5 CFM, greater than or equal to 3.75 CFM, greater than or equal to 4 CFM, greater than or equal to 4.25 CFM, greater than or equal to 4.5 CFM, or greater than or equal to 4.75 CFM. In some embodiments, a non-woven fiber web may have an air permeability of less than or equal to 5 CFM, less than or equal to 4.75 CFM, less than or equal to 4.5 CFM, less than or equal to 4.25 CFM, less than or equal to 4 CFM, less than or equal to 3.75 CFM, less than or equal to 3.5 CFM, less than or equal to 3.25 CFM, less than or equal to 3 CFM, less than or equal to 2.75 CFM, less than or equal to 2.5 CFM, less than or equal to 2.25 CFM, less than or equal to 2 CFM, less than or equal to 1.75 CFM, less than or equal to 1.5 CFM, less than or equal to 1.25 CFM, less than or equal to 1 CFM, less than or equal to 0.75 CFM, or less than or equal to 0.5 CFM. Combinations of these ranges are also possible (e.g., greater than or equal to 0.25 CFM and less than or equal to 5 CFM, greater than or equal to 0.5 CFM and less than or equal to 3 CFM, or greater than or equal to 0.75 CFM and less than or equal to 1.5 CFM). The air permeability of a non-woven fiber web may be determined in accordance with ASTM Test Standard D737-04 (2016) at a pressure of 125 Pa.

A non-woven fiber web described herein may have a variety of suitable values of tensile strengths. In some embodiments, a non-woven fiber web has a tensile strength in the machine direction of greater than or equal to 1 lb/inch, greater than or equal to 2 lb/inch, greater than or equal to 3 lb/inch, greater than or equal to 5 lb/inch, greater than or equal to 7 lb/inch, greater than or equal to 9 lb/inch, greater than or equal to 11 lb/inch, greater than or equal to 13 lb/inch, greater than or equal to 15 lb/inch, greater than or equal to 17 lb/inch, or greater than or equal to 19 lb/inch. In some embodiments, a non-woven fiber web has a tensile strength in the machine direction of less than or equal to 20 lb/inch, less than or equal to 19 lb/inch, less than or equal to 17 lb/inch, less than or equal to 15 lb/inch, less than or equal to 13 lb/inch, less than or equal to 11 lb/inch, less than or equal to 9 lb/inch, less than or equal to 7 lb/inch, less than or equal to 5 lb/inch, less than or equal to 3 lb/inch, or less than or equal to 2 lb/inch. Combinations of these ranges are also possible (e.g., greater than or equal to 1 lb/inch and less than or equal to 20 lb/inch, greater than or equal to 2 lb/inch and less than or equal to 15 lb/inch, or greater than or equal to 3 lb/inch and less than or equal to 10 lb/inch). Other ranges are also possible. The tensile strength in the machine direction of the non-woven fiber web may be determined according to the standard BCIS 03B (2018).

In some embodiments, a non-woven fiber web has a tensile strength in the cross direction of greater than or equal to 1 lb/inch, greater than or equal to 2 lb/inch, greater than or equal to 3 lb/inch, greater than or equal to 5 lb/inch, greater than or equal to 7 lb/inch, greater than or equal to 9 lb/inch, greater than or equal to 11 lb/inch, greater than or equal to 13 lb/inch, greater than or equal to 15 lb/inch, greater than or equal to 17 lb/inch, or greater than or equal to 19 lb/inch. In some embodiments, a non-woven fiber web has a tensile strength in the cross direction of less than or equal to 20 lb/inch, less than or equal to 19 lb/inch, less than or equal to 17 lb/inch, less than or equal to 15 lb/inch, less than or equal to 13 lb/inch, less than or equal to 11 lb/inch, less than or equal to 9 lb/inch, less than or equal to 7 lb/inch, less than or equal to 5 lb/inch, less than or equal to 3 lb/inch, or less than or equal to 2 lb/inch. Combinations of these ranges are also possible (e.g., greater than or equal to 1 lb/inch and less than or equal to 20 lb/inch, greater than or equal to 2 lb/inch and less than or equal to 15 lb/inch, or greater than or equal to 3 lb/inch and less than or equal to 10 lb/inch). Other ranges are also possible. The tensile strength in the cross direction of the non-woven fiber web may be determined according to the standard BCIS 03B (2018).

A non-woven fiber web described herein may have a variety of suitable values of compressibility. In some embodiments, a non-woven fiber web may have a compressibility of greater than or equal to 20%, greater than or equal to 22.5%, greater than or equal to 25%, greater than or equal to 27.5%, greater than or equal to 30%, greater than or equal to 32.5%, greater than or equal to 35%, greater than or equal to 37.5%, greater than or equal to 40%, greater than or equal to 42.5%, greater than or equal to 45%, greater than or equal to 47.5%, greater than or equal to 50%, greater than or equal to 52.5%, greater than or equal to 55%, greater than or equal to 57.5%, greater than or equal to 60%, or greater than or equal to 62.5%. In some embodiments, a non-woven fiber web may have a compressibility of less than or equal to 65%, less than or equal to 62.5%, less than or equal to 60%, less than or equal to 57.5%, less than or equal to 55%, less than or equal to 52.5%, less than or equal to 50%, less than or equal to 47.5%, less than or equal to 45%, less than or equal to 42.5%, less than or equal to 40%, less than or equal to 37.5%, less than or equal to 35%, less than or equal to 32.5%, less than or equal to 30%, less than or equal to 27.5%, less than or equal to 25%, or less than or equal to 22.5%. Combinations of these ranges are also possible (e.g., greater than or equal to 20% and less than or equal to 65%, greater than or equal to 25% and less than or equal to 65%, or greater than or equal to 30% and less than or equal to 65%). Other ranges are also possible.

The compressibility of a non-woven fiber web may be determined as follows. Briefly, a 2.5 cm by 2.5 cm sample of the non-woven fiber web may be compressed at 25° C. and over 100 seconds from an initial applied pressure of 0 kPa to a final applied pressure of 400 kPa. This may be accomplished by continuously increasing the applied pressure from 0 kPa to 400 kPa at a constant rate over 100 seconds. The thicknesses of the non-woven fiber web at applied pressure of 10 kPa and 400 kPa may be measured, and the compressibility may be calculated by applying the following formula: Compressibility=100%·[(thickness of the non-woven fiber web at 10 kPa)−(thickness of the non-woven fiber web at 400 kPa)]/(thickness of the non-woven fiber web at 10 kPa).

In some embodiments, a non-woven fiber web described herein may have a low thermal conductivity. In some embodiments, a non-woven fiber web may have a thermal conductivity of greater than or equal to 15 mW/(m·K), greater than or equal to 20 mW/(m·K), greater than or equal to 25 mW/(m·K), greater than or equal to 30 mW/(m·K), greater than or equal to 35 mW/(m·K), greater than or equal to 40 mW/(m·K), greater than or equal to 45 mW/(m·K), greater than or equal to 50 mW/(m·K), or greater than or equal to 55 mW/(m·K). In some embodiments, a non-woven fiber web may have a thermal conductivity of less than or equal to 60 mW/(m·K), less than or equal to 55 mW/(m·K), less than or equal to 50 mW/(m·K), less than or equal to 45 mW/(m·K), less than or equal to 40 mW/(m·K), less than or equal to 35 mW/(m·K), less than or equal to 30 mW/(m·K), less than or equal to 25 mW/(m·K), or less than or equal to 20 mW/(m·K). Combinations of these ranges are also possible (e.g., greater than or equal to 15 mW/(m·K) and less than or equal to 60 mW/(m·K), greater than or equal to 20 mW/(m·K) and less than or equal to 50 mW/(m·K), or greater than or equal to 25 mW/(m·K) and less than or equal to 40 mW/(m·K)). Other ranges are also possible. The thermal conductivity of the non-woven fiber web may be determined according to the standard ASTM C518-21 (2021) at 25° C.

In some embodiments, a non-woven fiber web described herein may have a high thermal stability. In some embodiments, the non-woven fiber web may have a thermal stability of greater than greater than or equal to 700° C., greater than or equal to 750° C., greater than or equal to 800° C., greater than or equal to 850° C., greater than or equal to 900° C., greater than or equal to 950° C., greater than or equal to 1000° C., greater than or equal to 1050° C., greater than or equal to 1100° C., or greater than or equal to 1150° C. In some embodiments, the non-woven fiber web may have a thermal stability of less than or equal to 1200° C., less than or equal to 1150° C., less than or equal to 1100° C., less than or equal to 1050° C., less than or equal to 1000° C., less than or equal to 950° C., less than or equal to 900° C., less than or equal to 850° C., less than or equal to 800° C., or less than or equal to 750° C. Combinations of these ranges are also possible (e.g. greater than or equal to 700° C. and less than or equal to 1200° C., or greater than 750° C. and less than or equal to 1,200° C.). Other ranges are also possible.

As used herein, the thermal stability of a non-woven fiber web refers to the maximum temperature at which the non-woven fiber web, upon being exposed to that temperature for 10 minutes, undergoes a shrinkage of less than 2% in the machine direction and less than 2% in the cross direction. The shrinkage in the machine and cross directions upon being exposed to a particular temperature may be determined by: (1) Placing a 100 mm (machine direction) by 100 mm (cross direction) sample of the non-woven fiber web into an oven pre-heated to that temperature; (2) Allowing the sample of the non-woven fiber web to remain in the oven for 10 minutes; (3) Allowing the sample of the non-woven fiber web to cool to 25° C.; (4) Measuring the length of the sample in the machine and cross directions; and (5) Applying the following formulas to determine the shrinkage in the machine and cross directions: Shrinkage in machine direction=100%·[(100 mm)−(length of the sample in the machine direction after step (4))]/(100 mm); and Shrinkage in cross direction=100%·[(100 mm)−(length of the sample in the cross direction after step (4))]/(100 mm).

In some embodiments, a non-woven fiber web described herein may have a relatively low flammability. In some embodiments, the non-woven fiber web may have a rating of V-0, 5VB, or 5VA under the UL 94 (2021) standard.

In some embodiments, a non-woven fiber web described herein may have a high breakdown voltage. In some embodiments, the non-woven fiber web may have a breakdown voltage of greater than or equal to 0.5 kV/mm, greater than or equal to 1 kV/mm, greater than or equal to 1.5 kV/mm, greater than or equal to 2 kV/mm, greater than or equal to 2.5 kV/mm, greater than or equal to 3 kV/mm, greater than or equal to 3.5 kV/mm, greater than or equal to 4 kV/mm, or greater than or equal to 4.5 kV/mm. In some embodiments, the non-woven fiber web may have a breakdown voltage of less than or equal to 5 kV/mm, less than or equal to 4.5 kV/mm, less than or equal to 4 kV/mm, less than or equal to 3.5 kV/mm, less than or equal to 3 kV/mm, less than or equal to 2.5 kV/mm, less than or equal to 2 kV/mm, less than or equal to 1.5 kV/mm, or less than or equal to 1 kV/mm. Combinations of these ranges are also possible (e.g., greater than or equal to 0.5 kV/mm and less than or equal to 5 kV/mm, greater than or equal to 1 kV/mm and less than or equal to 5 kV/mm, or greater than or equal to 1.5 kV/mm and less than or equal to 5 kV/mm). Other ranges are also possible.

The breakdown voltage of a non-woven fiber web can be measured in accordance with ASTM D-49-09 (2013).

In some embodiments, a phase that is a non-woven fiber web is fabricated by a wet laying process. In general, a wet laying process involves mixing together fibers of one or more type; for example, a plurality of glass fibers may be mixed together on its own or with a plurality of synthetic fibers. to provide a fiber slurry. The slurry may be, for example, an aqueous-based slurry. In some embodiments, fibers are optionally stored separately, or in combination, in various holding tanks prior to being mixed together.

In some embodiments, each plurality of fibers may be mixed and pulped together in separate containers. As an example, a plurality of glass fibers may be mixed and pulped together in one container and a plurality of synthetic fibers (e.g., multicomponent fibers) may be mixed and pulped in a second container. The pluralities of fibers may subsequently be combined together into a single fibrous mixture. Appropriate fibers may be processed through a pulper before and/or after being mixed together. In some embodiments, combinations of fibers are processed through a pulper and/or a holding tank prior to being mixed together. It can be appreciated that other components may also be introduced into the mixture (e.g., additives). Furthermore, it should be appreciated that other combinations of fiber types may be used in fiber mixtures, such as the fiber types described herein.

A wet laying process may comprise applying a single dispersion (e.g., a pulp) in a solvent (e.g., an aqueous solvent such as water) or slurry onto a wire conveyor in a papermaking machine (e.g., a fourdrinier or a rotoformer) to form a single non-woven fiber web supported by the wire conveyor. Vacuum may be continuously applied to the dispersion of fibers during the above process to remove the solvent from the fibers, thereby resulting in an article containing the single non-woven fiber web. In some embodiments, a resin may be applied onto the article to impart advantageous properties (e.g., enhanced mechanical strength, etc.) to the article.

Any suitable method for creating a fiber slurry may be used. In some embodiments, further additives are added to the slurry to facilitate processing. The temperature may also be adjusted to a suitable range, for example, between 33° F. and 100° F. (e.g., between 50° F. and 85° F.). In some cases, the temperature of the slurry is maintained. In some instances, the temperature is not actively adjusted.

In some embodiments, a wet laying process uses similar equipment as in a conventional papermaking process, for example, a hydropulper, a former or a headbox, a dryer, and/or an optional converter. A non-woven fiber web can also be made with a laboratory hand sheet mold in some instances. As discussed above, the slurry may be prepared in one or more pulpers. After appropriately mixing the slurry in a pulper, the slurry may be pumped into a headbox where the slurry may or may not be combined with other slurries. Other additives may or may not be added. The slurry may also be diluted with additional water such that the final concentration of the fibers is in a suitable range, such as for example, between about 0.1% and 0.5% by weight.

In some cases, the pH of the slurry may be adjusted as desired. For instance, fibers of the slurry may be dispersed under acidic or neutral conditions.

Before the slurry is sent to a headbox, the slurry may optionally be passed through centrifugal cleaners and/or pressure screens for removing undesired material (e.g., unfiberized material). The slurry may or may not be passed through additional equipment such as refiners or deflakers to further enhance the dispersion of the fibers. For example, deflakers may be useful to smooth out or remove lumps or protrusions that may arise at any point during formation of the fiber slurry. Fibers may then be collected on to a screen or wire at an appropriate rate using any suitable equipment, e.g., a fourdrinier, a rotoformer, or an inclined wire fourdrinier.

As described above, in some embodiments, a non-woven fiber web further comprises one or more non-fibrous components, such as thermal conductivity-reducing particles and/or an aerogel. Such species may be incorporated into a non-woven fiber web during a process by which the non-woven fiber web is formed (e.g., a wet laying process) and/or may be added to the non-woven fiber web after formation (e.g., after a wet laying process). When the former technique is employed, the thermal conductivity-reducing particles and/or the aerogel (and/or a precursor thereto) may be incorporated into the mixture being wet laid as an additive (e.g., a particulate additive, a non-particulate additive). For example, thermal conductivity-reducing particles and/or particulate aerogels may be incorporated into the mixture being wet laid as an additive. When the latter technique is employed the thermal conductivity-reducing particles and/or the aerogel (and/or a precursor thereto) may be infiltrated into a non-woven fiber web (e.g., in particulate form, in non-particulate form). In some embodiments, when a non-woven fiber web comprises an aerogel, a precursor to an aerogel reacts in the non-woven fiber web (and/or mixture being wet laid) to form the aerogel after incorporation thereinto.

As described above, in some embodiments, an already-formed non-woven fiber web may be impregnated with an aerogel precursor. A non-limiting method of impregnating the non-woven fiber web with the aerogel may comprise a first step, wherein reagents are mixed to form an aerogel precursor, which is impregnated into a non-woven fiber web. The non-woven fiber web may then be chemically aged in aging fluid, which may be or comprise a same solvent as the aerogel precursor (e.g., the aging fluid may be ethanol). During chemical aging, the aerogel precursor may undergo cross-linking to form a gel. The solvent and the aging fluid (if different) may then be removed from the non-woven fiber web using a supercritical fluid, such as supercritical CO₂. Once the solvent (and, in some instances, the aging fluid) has been removed, the non-woven fiber web may be heat dried (e.g., heat-dried in air), leaving an aerogel within the non-woven fiber web.

A non-woven fiber web impregnated with an aerogel precursor may be aged in an aging fluid for any of a variety of suitable time periods. In some embodiments, a non-woven fiber web impregnated with an aerogel precursor is aged in an aging fluid for a period of greater than or equal to 6 hours, greater than or equal to 8 hours, greater than or equal to 10 hours, greater than or equal to 12 hours, greater than or equal to 14 hours, greater than or equal to 6 hours, greater than or equal to 6 hours, or greater than or equal to 16 hours. In some embodiments, a non-woven fiber web impregnated with an aerogel precursor is aged in an aging fluid for a period of less than or equal to 48 hours, less than or equal to 44 hours, less than or equal to 40 hours, less than or equal to 36 hours, less than or equal to 32 hours, less than or equal to 30 hours, less than or equal to 28 hours, less than or equal to 26 hours, less than or equal to 24 hours, less than or equal to 22 hours, less than or equal to 20 hours, less than or equal to 18 hours, less than or equal to 16 hours, less than or equal to 14 hours, less than or equal to 12 hours, or less than or equal to 10 hours. Combinations of these ranges are also possible (e.g., greater than or equal to 6 hours and less than or equal to 48 hours). Other ranges are also possible.

Any of a variety of volume ratios of aging fluid to aerogel precursor may be used during aging. In some embodiments, a volume ratio of aging fluid to aerogel precursor is greater than or equal to 1:1 greater than or equal to 2:1 greater than or equal to 3:1 greater than or equal to 4:1, greater than or equal to 5:1, or greater than or equal to 6:1. In some embodiments, a volume ratio of aging fluid to aerogel precursor is less than or equal to 20:1, less than or equal to 15:1, less than or equal to 10:1, or less than or equal to 5:1. Combinations of these ranges are also possible (e.g., greater than or equal to 1:1 and less than or equal to 20:1). Other ranges are also possible.

An aged non-woven fiber web impregnated with an aerogel precursor may be dried for any of a variety of suitable time periods. In some embodiments, a non-woven fiber web is dried for a period of greater than or equal to 15 minutes, greater than or equal to 30 minutes, greater than or equal to 45 minutes, greater than or equal to 60 minutes, greater than or equal to 90 minutes, or greater than or equal to 2 hours. In some embodiments, a non-woven fiber web is dried for a period of less than or equal to 12 hours, less than or equal to 8 hours, less than or equal to 6 hours, less than or equal to 4 hours, less than or equal to 3 hours, or less than or equal to 2 hours. Combinations of these ranges are also possible (e.g., greater than or equal to 15 minutes and less than or equal to 12 minutes). Other ranges are also possible.

An aged non-woven fiber web impregnated with an aerogel precursor may be dried at any of a variety of temperatures. In some embodiments, a non-woven fiber web is dried at a temperature of greater than or equal to 80° C., greater than or equal to 85° C., greater than or equal to 90° C., greater than or equal to 95° C., greater than or equal to 95° C., greater than or equal to 100° C., greater than or equal to 105° C., or greater than or equal to 110° C. In some embodiments, a non-woven fiber web is dried at a temperature of less than or equal to 130° C., less than or equal to 125° C., less than or equal to 120° C., less than or equal to 115° C., less than or equal to 110° C., or less than or equal to 105° C. Combinations of these ranges are also possible (e.g., greater than or equal to 80° C. and less than or equal to 130° C.). Other ranges are also possible.

An aerogel precursor may comprise one or more aerogel-forming reagents which may react to form an aerogel. In some embodiments, the aerogel-forming reagent(s) may undergo a sol-gel reaction to form the aerogel. As a first step, the aerogel precursor may be converted into a sol by reaction. Then, the sol may react to form the aerogel. As described above, it is possible for the aerogel precursor and/or the sol to be introduced into a non-woven fiber web prior to the reaction to form the aerogel and/or a fully-formed aerogel may be introduced into a non-woven fiber web. In some embodiments, an aerogel precursor and/or a sol is introduced into a non-woven fiber web while dissolved and/or suspended in a solvent, such as ethanol.

Sol-gel reactions employed to form aerogels may comprise hydrolysis and/or cross-linking. An aerogel-forming reagent may be and/or include a metal alkoxide having the formula M(OR)ₓ, where M is Al, Si, or Ti, and R is an alkyl group (e.g., a methyl group, an ethyl group, a propyl group, a butyl group). Generally, when M is Al, x=3; when M is Si, x=4; and when M is Ti, x=4. An aerogel-forming reagent may be and/or comprise a species configured to react with a metal alkoxide, such as water. In one non-limiting example, the aerogel-forming reagents comprise tetraethyl orthosilicate (TEOS) and water. In such embodiments, the reaction of TEOS and water would produce a silica aerogel and ethanol. This reaction is shown schematically below:

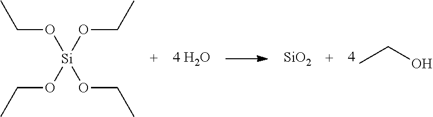

The above reaction may be performed using an acidic catalyst or a basic catalyst.

As another non-limiting example, in some embodiments aerogel-forming reagents comprise tetraethyl orthosilicate (TEOS), alkyltriethoxysilane (RSi(OC₂H₅)₃), and water. In the alkyltriethyoxysilane, R may be an alkyl group (e.g., a methyl group, an ethyl group, a propyl group, and/or a butyl group). The reaction of TEOS, RSi(OC₂H₅)₃, and water may be performed using an acidic catalyst or a basic catalyst. The reaction of TEOS, RSi(OC₂H₅)₃, and water may produce ethanol and a silica hybrid aerogel having the formula (SiO₂)ₓ (RSiO_{1.5})_{y}.

Non-woven fiber webs as described herein may be used in any of a variety of suitable batteries. Generally, a battery comprises a plurality of electrochemical cells, including a first electrochemical cell and a second electrochemical cell. In each electrochemical cell, electrons may pass from a first battery plate (e.g., a negative battery plate) to a second battery plate (e.g., a positive battery plate) during discharge and from the second battery plate to the first battery plate during charge. Positively charged ions may also flow through the electrochemical cell during each of these processes in the direction opposite to the direction of electron flow. Each electrochemical cell may further comprise an electrolyte configured to transport these ions. As described above, the batteries described herein may further comprise a non-woven fiber web described herein between some of the pairs of electrochemical cells. Such non-woven fiber webs may be particularly suitable for thermally insulating the electrochemical cells from each other.

In some embodiments, a battery described herein comprises a plurality of lithium metal electrochemical cells and/or lithium-ion electrochemical cells. In such embodiments, lithium ions may be the positive ions that are transported between electrodes during charging and discharging. Without wishing to be bound by any particular theory, it is believed that such batteries may be particularly prone overheating during use, and so may especially benefit from the inclusion of the thermal insulation that may be provided by a non-woven fiber web as described herein.

Generally, the batteries described herein comprise a plurality of electrochemical cells and a non-woven fiber web. In some embodiments, a battery comprises greater than or equal to 2, greater than or equal to 3, greater than or equal to 5, greater than or equal to 10, greater than or equal to 15, greater than or equal to 20, greater than or equal to 30, or greater than or equal to 50 electrochemical cells. In some embodiments, a battery comprises less than or equal to 250, less than or equal to 225, less than or equal to 200, less than or equal to 175, less than or equal to 150, less than or equal to 125, less than or equal to 100, less than or equal to 75, less than or equal to 50, or less than or equal to 25 electrochemical cells. Combinations of these ranges are also possible (e.g., greater than or equal to 2 and less than or equal to 250, greater than or equal to 3 and less than or equal to 100, or greater than or equal to 5 and less than or equal to 1 electrochemical cells). Other ranges are also possible.

In some embodiments, at least some pairs of nearest neighbor electrochemical cells of the battery are separated from one another by the non-woven fiber web. In some embodiments greater than or equal to 1%, greater than or equal to 5%, greater than or equal to 10%, greater than or equal to 20%, greater than or equal to 50%, greater than or equal to 80%, or greater than or equal to 90% of pairs of nearest neighbor electrochemical cells are separated from one another by a non-woven fiber web. In some embodiments, less than or equal to 100%, less than or equal to 90%, less than or equal to 80%, or less than or equal to 50% of pairs of nearest neighbor electrochemical cells are separated from one another by a non-woven fiber web. Combinations of these ranges are also possible (e.g., greater than or equal to 1% and less than or equal to 100%, greater than or equal to 5% and less than or equal to 90%, or greater than or equal to 20% and less than or equal to 80% of pairs of nearest neighbor electrochemical cells are separated from one another by a non-woven fiber web). Other ranges are also possible.

### Example 1

This Example describes the preparation and selected properties of several non-woven fiber webs suitable for use as thermal barrier materials.

The non-woven fiber webs were fabricated by wet laying using substantially identical processes, which is briefly summarized below. The fibers and particles to be included in the non-woven fiber web were dispersed to create a slurry. This slurry was transferred to a Fourdrinier paper machine, in which water was allowed to drain under vacuum to form the non-woven fiber webs. Further water was removed from the non-woven fiber web by passing the non-woven fiber web through a hot zone. Subsequently, the non-woven fiber web was saturated with a latex comprising particles of a resin to be included therein. The non-woven fiber web was then again dewatered in a Fourdrinier paper machine and upon the application of heat as described above. Finally, the non-woven fiber web was wound into rolls.

Various physical properties of each of the non-woven fiber webs were measured. Additionally, the morphologies of each sample were inspected under scanning electron microscope (SEM).

Table 1 shows the composition and selected physical properties of each non-woven fiber web.

TABLE 1
Composition and properties of the non-woven fiber webs.

| | | | |
|---|---|---|---|
| Web 1 | Web 2 | Web 3 | Web 4 |

Fiber Types

| | | | | |
|---|---|---|---|---|
| Microglass Fibers (wt %) | 25 | 25 | 25 | 28 |
| Chopped Strand Glass Fibers (wt %) | 20 | 15 | 15 | 65 |
| Synthetic Fibers - Monocomponent Binder | 1 | 1 | 1 | 1 |
| Fibers (wt %) | | | | |
| Synthetic Fibers - Bicomponent Binder Fibers | 3 | 3 | 3 | 6 |
| (wt %) | | | | |
| Resin (wt %) | 6 | 6 | 6 | 0 |
| Silica Particles (wt %) | 45 | 0 | 0 | 0 |
| Mica Particles (wt %) | 0 | 50 | 50 | 0 |

Fiber Properties

| | | | | |
|---|---|---|---|---|
| Average Diameter of Microglass Fibers | 1.4 | 1.4 | 1.4 | 0.8 |
| (microns) | | | | |
| Average Diameter of Chopped Strand Glass | 7.0 | 7.0 | 7.0 | 7.0 |
| Fibers (microns) | | | | |
| Average Diameter of Monocomponent Binder | 12.0 | 12.0 | 12.0 | 12.0 |
| Fibers (microns) | | | | |
| Average Diameter of Bicomponent Binder | 12.0 | 12.0 | 12.0 | 12.0 |
| Fibers (microns) | | | | |
| Average Diameter of Silica Particles (microns) | 10 | N/A | N/A | N/A |
| Average Diameter of Mica Particles (microns) | N/A | 37.5 | 37.5 | N/A |

Physical Properties

| | | | | |
|---|---|---|---|---|
| Basis Weight (g/m²) | 267 | 276 | 471 | 185 |
| Thickness (mm) | 1.04 | 0.93 | 1.68 | 1.05 |
| Air Permeability (CFM) | 1.01 | 1.05 | 1.01 | 7.87 |
| Breakdown Voltage (kV/mm) | 1.59 | 1.62 | 2.01 | 2.58 |
| Thermal Conductivity (mW/(m · K)) | 28.5 | 26 | — | — |
| Achieve Rating of V-0 or Higher under UL 94 | Yes | Yes | Yes | Yes |
| (2021)? | | | | |
| Compressibility (%) | 27.7 | 45.0 | 45.0 | 57.0 |
| Tensile Strength in the Machine Direction | 4.7 | 6.6 | 13.2 | 10.0 |
| (lb/in) | | | | |
| Tensile Strength in the Cross Direction (lb/in) | 4.2 | 7.2 | 11.1 | 2.1 |

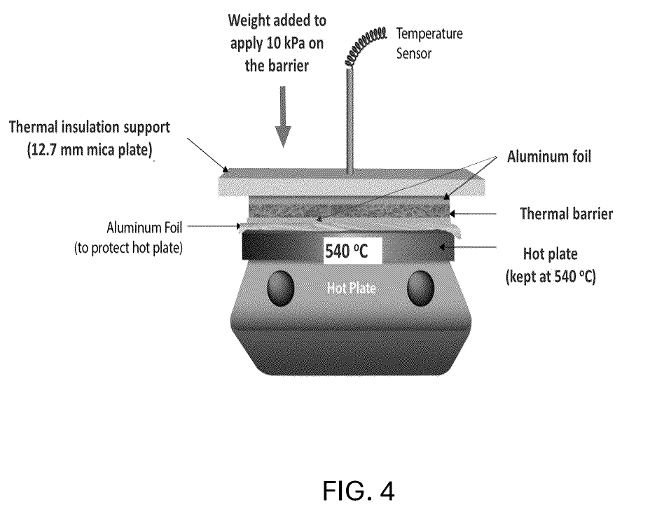

The thermal insulation performance of 2 inch by 2 inch samples of the non-woven fiber webs described above were measured by employing the experimental set up shown in FIG. 4. As can be seen in FIG. 4, each non-woven fiber web (labeled therein as a “Thermal barrier”), was placed on a hot plate set at 540° C. The side of the thermal barrier in contact with the hot plate is referred to as the “hot side”. Two layers of aluminum foil were positioned between the hot plate and the non-woven fiber web. A further layer of aluminum foil was placed on the opposite side of the non-woven fiber web, referred to as the “cold side”, and a 12.7 mm-thick mica plate was placed on this further layer of aluminum foil. Then, weight was added to the mica plate in order to apply a pressure of 10 kPa to the non-woven fiber web. After these assembly steps were completed, the temperature on the side of the mica plate opposite the aluminum foil (the cold side) was measured as a function of time for ten minutes.

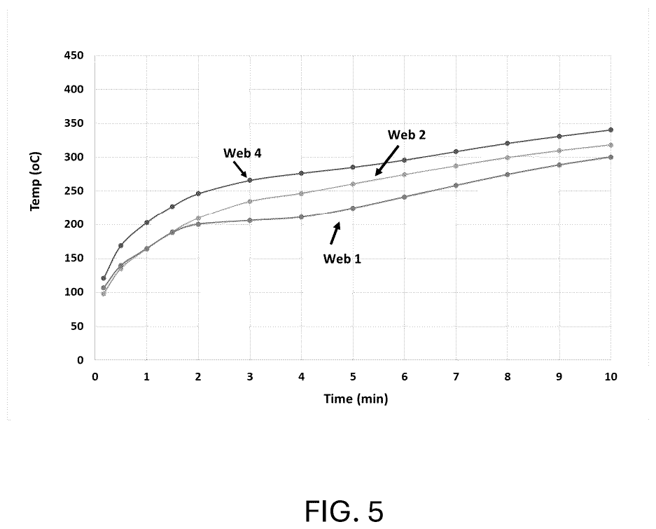

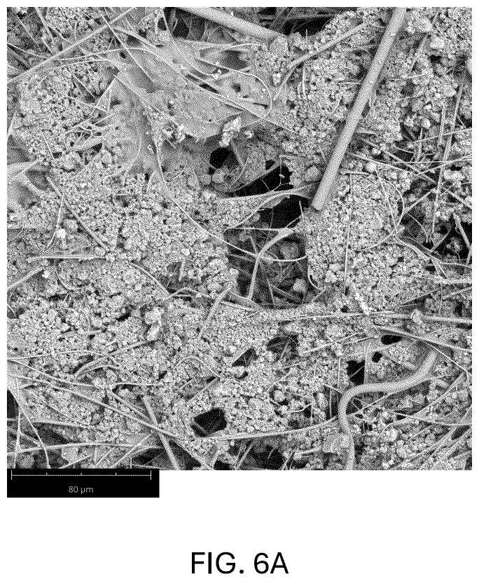

FIG. 5 shows the above-described measured temperature as a function of time for Webs 1, 2, and 4. As can be seen from FIG. 5, Webs 1 and 2 displayed lower temperatures on their cold sides in comparison to Web 4, indicating their reduced thermal conductivity relative to Web 4 and thus superior thermal insulation performance

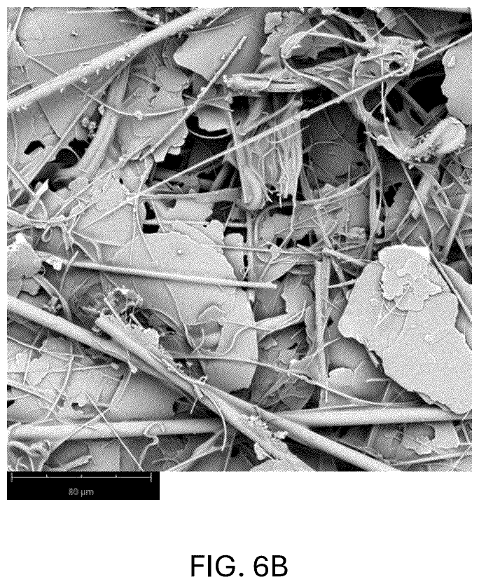

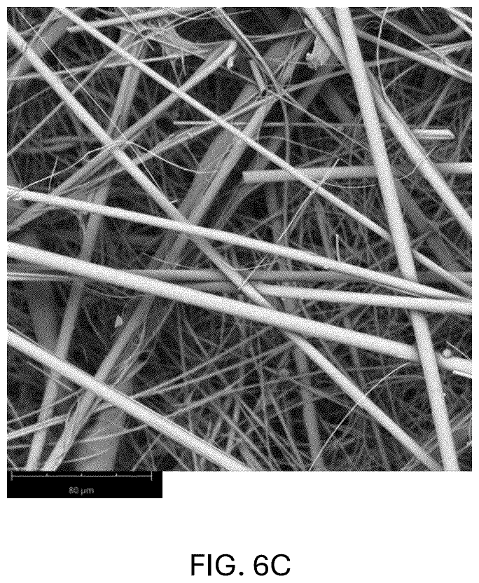

FIG. 6A shows an SEM image of Web 1, FIG. 6B shows an SEM image of Web 2, and FIG. 6C shows an SEM image of Web 4. These SEM images suggest that particles filled in pores and reduced the mean flow pore sizes of the non-woven fiber webs in which they were positioned.

### Example 2

This Example describes the preparation and selected properties of several non-woven fiber webs suitable for use as thermal barrier materials.

Each of the non-woven fiber webs in this Example was fabricated as a hand sheet. Accordingly, each layer was produced on a lab bench top, where a fiber mixture containing an appropriate combination of components was added to a hand sheet mold. Once positioned in the hand sheet mold, the fiber mixture was dewatered by vacuum suction and subsequently dried by heat application, so as to form a non-woven fiber web.

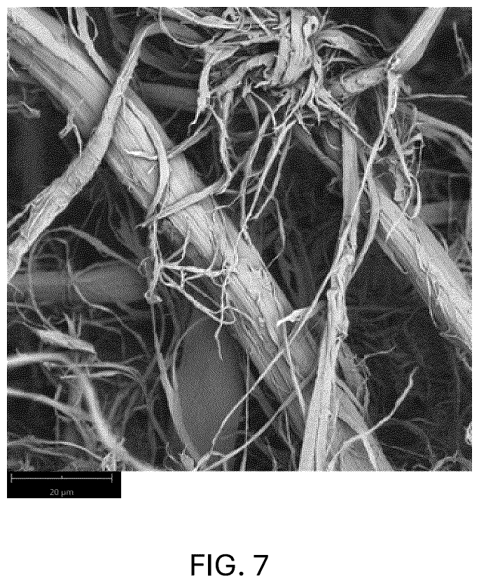

Some of the fabricated non-woven fiber webs comprised fibrillated fibers. These fibers were fabricated by fibrillating chopped strand aramid fibers comprising polyparaphenylene terephthalamide. A micrograph of the fibrillated fibers is shown in FIG. 7. The thermal stability of the fibrillated fibers was measured using thermal gravimetric analysis (TGA). The fibrillated aramid fibers had a high thermal stability, not beginning to decompose until a temperature of approximately 470° C. had been reached. Polyethylene and polypropylene have much lower thermal stability and begin to decompose at temperatures of between 250-340° C.

Various physical properties of each of the non-woven fiber webs were measured.

Table 2 shows the composition and selected physical properties of each non-woven fiber web.

TABLE 2
Composition and properties of the non-woven fiber webs.

| | |
|---|---|
| Web 5 | Web 6 |

Fiber Types

| | | |
|---|---|---|
| Microglass Fibers (wt %) | 25 | 0 |
| Chopped Strand Glass Fibers (wt %) | 15 | 35 |
| Synthetic Fibers - Monocomponent Binder Fibers (wt %) | 1 | 1 |
| Synthetic Fibers - Bicomponent Binder Fibers (wt %) | 3 | 3 |
| Resin (wt %) | 6 | 6 |
| Fibrillated Aramid Fibers (wt %) | 0 | 5 |
| Mica Particles (wt %) | 50 | 50 |

Fiber Properties

| | | |
|---|---|---|
| Average Diameter of Microglass Fibers (microns) | 1.4 | N/A |
| Average Diameter of Chopped Strand Glass Fibers (microns) | 7.0 | 7.0 |
| Average Diameter of Monocomponent Binder Fibers (microns) | 12.0 | 12.0 |
| Average Diameter of Bicomponent Binder Fibers (microns) | 12.0 | 12.0 |
| Average Diameter of Aramid Fibers (microns) | N/A | N/A |
| Average Diameter of Mica Particles (microns) | 37.5 | 37.5 |

Physical Properties

| | | |
|---|---|---|
| Basis Weight (g/m²) | 322 | 334 |
| Thickness (mm) | 1.02 | 1.06 |
| Air Permeability (CFM) | 0.77 | 1.73 |
| Breakdown Voltage (kV/mm) | 2.62 | 2.36 |
| Thermal Conductivity (mW/(m · K)) | | — |
| Achieve Rating of V-0 or Higher under UL 94 (2021)? | Yes | Yes |
| Compressibility (%) | 47.3 | 53.0 |
| Tensile Strength (lb/in) | 11.4 | 8.6 |

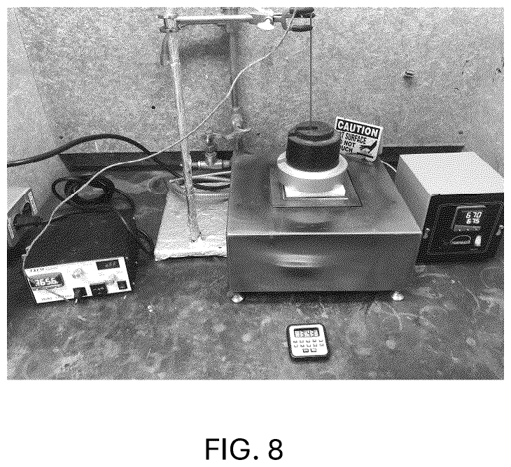

The thermal insulation performance of samples of the non-woven fiber webs described above were measured by employing the experimental set up shown in FIG. 8. As can be seen in FIG. 8, each non-woven fiber web (labeled therein as a “Thermal barrier”), was placed on a hot plate. The hot plate was set at 675° C. The side of the thermal barrier in contact with the hot plate is referred to as the “hot side”. Before the test, the sample having a dimension of 4.5″ by 4.5″ was attached to a ceramic plate with a dimension of 4″ by 4″. Then, a weight was added to the ceramic plate in order to apply a pressure of 5 kPa to the non-woven fiber web. After these assembly steps were completed, the sample was placed in contact with the hot plate and the temperature for the side of the barrier in contact with the ceramic plate was measured as a function of time for fifteen minutes.

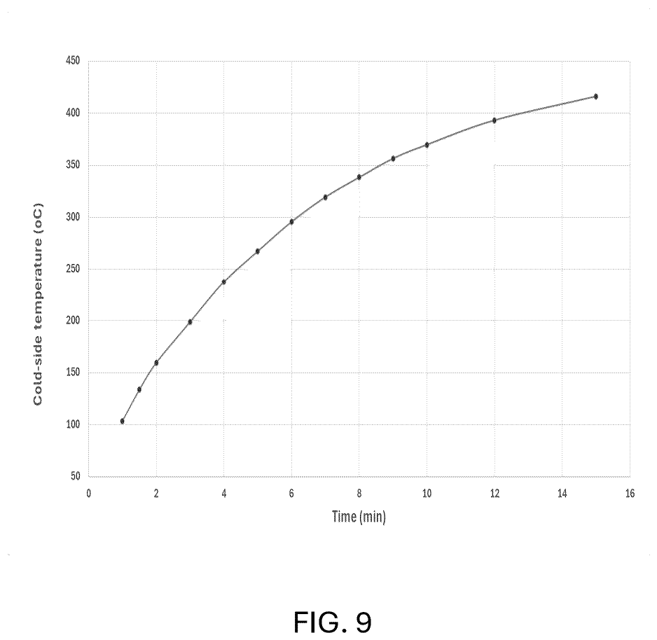

FIG. 9 shows the above-described measured temperature as a function of time for Web 6. As can be seen from FIG. 9, Web 6 showed good insulating performance, with a temperature differential of over 250° C. between the hot side and the cold side of the sample.

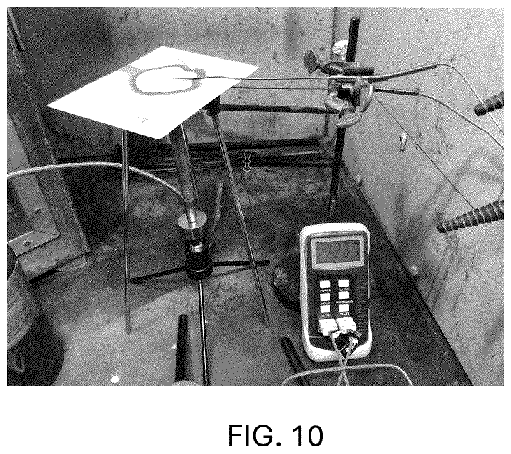

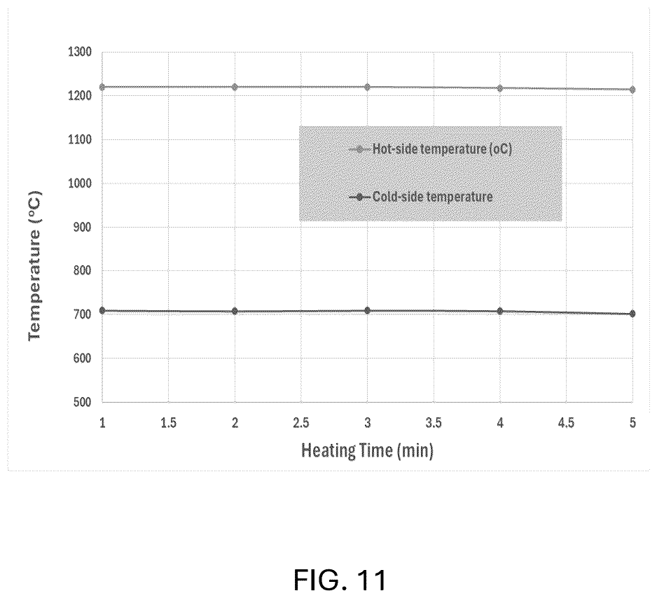

A torch test was also conducted for Web 6 using the experimental set up shown in FIG. 10, in which one side of a sample (the “hot side” of the sample) of the web was subjected to the heat of a flame, and the temperature of the sample on the side not exposed to the flame (the “cold side” of the sample) was measured for a period of 5 minutes. As shown in FIG. 11, Web 6 also showed good insulating performance in the torch test, with a temperature differential of over 500° C. between the hot side and the cold side of the sample.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A thermal barrier material, comprising:
a non-woven fiber web, comprising:
microglass fibers;
synthetic fibers; and
thermal conductivity-reducing particles,
wherein:
the synthetic fibers make up less than or equal to 60 wt % of the non-woven fiber web, and
the non-woven fiber web has an air permeability less than or equal to 5 CFM.

2. A thermal barrier material, comprising:
a non-woven fiber web, comprising:
microglass fibers; and
thermal conductivity-reducing particles,
wherein:
the microglass fibers make up greater than or equal to 20 wt % of the non-woven fiber web, and
the non-woven fiber web has an air permeability less than or equal to 5 CFM.

3-12. (canceled)

13. A thermal barrier material as in claim 1, wherein the thermal conductivity-reducing particles comprise silica.

14-15. (canceled)

16. A thermal barrier material as in claim 1, wherein the thermal conductivity-reducing particles comprise silicon carbide.

17. A thermal barrier material as in claim 1, wherein the thermal conductivity-reducing particles comprise mica.

18. A thermal barrier material as in claim 1, wherein the non-woven fiber web comprises a silica aerogel.

19. A thermal barrier material as in claim 1, wherein the thermal conductivity-reducing particles make up greater than 35 wt % and less than or equal to 55 wt % of the non-woven fiber web.

20-21. (canceled)

22. A thermal barrier material as in claim 1, wherein the thermal conductivity-reducing particles have a refractive index greater than or equal to 1.5 at 25° C. for a wavelength of greater than or equal to 400 nm and less than or equal to 1 mm.

23-24. (canceled)

25. A thermal barrier material as in claim 1, wherein the non-woven fiber web has a thermal conductivity of less than or equal to 60 mW/(m·K).

26. A thermal barrier material as in claim 1, wherein the non-woven fiber web has a breakdown voltage greater than or equal to 1 kV/mm.

27-30. (canceled)

31. A thermal barrier material as in claim 1, wherein the non-woven fiber web has a mean flow pore size less than or equal to 3 microns.

32. A thermal barrier material as in claim 1, wherein the non-woven fiber web has a maximum pore size less than or equal to 20 microns.

33. (canceled)

34. A thermal barrier material as in claim 1, wherein the non-woven fiber web has a thermal stability of greater than or equal to 700° C.

35. A thermal barrier material as in claim 1, wherein the non-woven fiber web has a V-0 rating under UL 94 (2021).

36-47. (canceled)

48. A thermal barrier material as in claim 1, wherein the non-woven fiber web further comprises a resin.

49. A thermal barrier material as in claim 48, wherein the resin comprises poly(vinyl chloride) and/or poly(vinylidene chloride).

50. (canceled)

51. A battery comprising a plurality of electrochemical cells comprising a first electrochemical cell and a second electrochemical cell, wherein the thermal barrier material of claim 1 is positioned between the first and second electrochemical cells.

52. A battery comprising a plurality of modules comprising a first module and a second module, wherein the thermal barrier material of claim 1 is positioned between the first and second modules.

53. A thermal barrier material as in claim 1, further comprising fibrillated synthetic fibers.

54-56. (canceled)

57. A battery, comprising:
a plurality of modules comprising a first module and a second module; and
a non-woven fiber web, wherein:
the first module comprises a plurality of electrochemical cells,
the plurality of electrochemical cells comprises a stack of electrochemical cells,
the stack of electrochemical cells comprises a first electrochemical cell and a second electrochemical cell,
the non-woven fiber web is positioned between the first and second modules, between the first and second electrochemical cells, at an end of the stack of electrochemical cells, on top of the stack of electrochemical cells, below the stack of electrochemical cells, and/or along a side of the stack of electrochemical cells,
the non-woven fiber web comprises microglass fibers and thermal conductivity-reducing particles, and
the non-woven fiber web has an air permeability less than or equal to 5 CFM.
